(19) United States
(12) Patent Application Publication
(10) Pub. No.: US 2012/0013839 A1
(43) Pub. Date: Jan. 19, 2012

(54) DISPLAY PANEL AND DISPLAY DEVICE

(75) Inventors: Kazunari Katsumoto, Osaka (JP); Yasuyoshi Kaise, Osaka (JP)

(73) Assignee: SHARP KABUSHIKI KAISHA, Osaka (JP)

(21) Appl. No.: 13/259,089

(22) PCT Filed: Nov. 12, 2009
(86) PCT No.: PCT/JP2009/069251

§ 371 Date: Sep. 29, 2011

(30) Foreign Application Priority Data
Mar. 27, 2009 (JP) 2009-078405

(51) Int. Cl. G02F 1/1343

(52) U.S. Cl. 349/139

(57) ABSTRACT

Provided are a display panel and a display device which are capable of suppressing the occurrence of horizontal crosstalk and ensuring the aperture ratio of the whole display panel. The auxiliary capacitance electrode of a pixel forming portion (110) of a liquid crystal panel (10) is connected to an auxiliary capacitance wiring line (Cs) and an opposite electrode (152). Therefore, if the potential of the auxiliary capacitance wiring line (Cs) is drawn in by the parasitic capacitance of the intersection of the auxiliary capacitance wiring line (Cs) and a data signal line (SL), the potential of the auxiliary capacitance wiring line (Cs) is quickly recovered to the original common potential, and it is thereby possible to suppress the occurrence of horizontal crosstalk. The auxiliary capacitance electrode (142) of a pixel forming portion (120) of the liquid crystal panel (10) is connected only to the auxiliary capacitance wiring line (Cs). Thus, since the aperture ratio of the pixel forming portion (120) is larger than that of the pixel forming portion (110), it is possible to ensure a large aperture ratio in the whole display panel (10). A columnar spacer (194) is disposed at the position opposite to a contact pad (144).

### TECHNICAL FIELD

The present invention relates to a display panel and a display device, and more specifically, to an active matrix system display panel and display device equipped with an auxiliary capacitance.

### BACKGROUND ART

At a pixel forming portion of an active matrix system liquid crystal display device, an auxiliary capacitance with a large capacitance value is formed in order to supplement voltage kept at a pixel capacitance and to stabilize voltage that is applied to a liquid crystal layer.

In such a liquid crystal display device, in addition to a data signal line and a scan signal line, an auxiliary capacitance wiring line is formed in parallel with the scan signal line. However, due to a parasitic capacitance that occurs at an intersection of the data signal line and the auxiliary capacitance wiring line, when potential of the data signal line changes, potential of the auxiliary capacitance wiring line, which is supposed to be the same potential as a common potential of an opposite electrode, is drawn in by the change in the potential of the data signal line and is lowered.

FIG. 23 is a view showing a change in the potential of an auxiliary capacitance electrode in a conventional pixel forming portion due to the parasitic capacitance at the intersection of the auxiliary capacitance wiring line and the data signal line. As shown in FIG. 23, the potential of an auxiliary capacitance electrode is lowered by V1 compared to the original potential due to a change in the potential of the data signal line, but is recovered as time passes to the same potential as a common potential Vcom of the opposite electrode. However, when a gate of a thin film transistor (hereinafter referred to as “TFT”), which functions as a switching element of the pixel forming portion, becomes an off-state before the potential of the auxiliary capacitance electrode is recovered to the same potential as the common potential Vcom of the opposite electrode, the potential of the auxiliary capacitance electrode only recovers to the potential that is lower than the common potential Vcom by V2. Accordingly, even after the gate of the TFT became an off-state, the potential of the auxiliary capacitance electrode continues to change until the potential is recovered to the common potential Vcom. When the potential of the auxiliary capacitance electrode changes in such a manner, voltage applied to the liquid crystal layer also changes, and therefore, light transmittance of the liquid crystal layer changes as well. As a result, a phenomenon called a horizontal crosstalk, which is a change in brightness of an image displayed on the liquid crystal panel, appears.

Furthermore, if the same potential as the common potential Vcom of the opposite electrode is applied to the auxiliary capacitance wiring line at the edge of the liquid crystal panel, the applied potential is lowered in accordance with a distance from the application point due to a resistance of the auxiliary capacitance wiring line. Therefore, time it takes for the potential of the auxiliary capacitance electrode, which has been drawn in by the parasitic capacitance by V1, to recover to the same potential as the common potential Vcom also becomes longer in accordance with the distance from the application point. As a result, voltage applied to the liquid crystal layer also becomes smaller in accordance with the distance from the application point, and a belt-like shaped bright region and a dark region thereby appear on the screen.

Disclosed in Patent Document 1 is a liquid crystal display device that prevents such a horizontal crosstalk due to the parasitic capacitance at the intersection of the auxiliary capacitance wiring line and the data signal line. Japanese Patent Application Laid-Open Publication Hei No. 10-268356 discloses a liquid crystal display device in which an auxiliary capacitance electrode is formed in an island-shape separated for each pixel forming portion to eliminate an intersection of the auxiliary capacitance electrode and the data signal line, and to prevent the parasitic capacitance. Meanwhile, an opposite electrode that is formed on a surface of an opposite substrate is also formed on the side surfaces as well as the bottom surface of a columnar spacer, which is disposed such that it sticks out of the opposite substrate. Because the opposite electrode, which is formed on the bottom surface of this spacer, comes in contact electrically with the auxiliary capacitance electrode, a common potential is applied from the opposite electrode to the island-shaped auxiliary capacitance electrode in each pixel forming portion. In this case, the potential of the auxiliary capacitance electrode is not affected by the parasitic capacitance that occurs between the data signal line and the auxiliary capacitance wiring line, and therefore, the occurrence of the horizontal crosstalk can be suppressed.

### RELATED ART DOCUMENTS

### Patent Documents

Patent Document 1: Japanese Patent Application Laid-Open Publication Hei No. 10-268356

### SUMMARY OF THE INVENTION

### Problems to be Solved by the Invention

In the liquid crystal display device of Patent Document 1, the auxiliary capacitance electrode is placed adjacent to the data signal line. Therefore, the potential of the auxiliary capacitance electrode is affected by a change in potential of the data signal line due to the parasitic capacitance that occurs between the auxiliary capacitance electrode and the data signal line. Accordingly, there is a problem of the occurrence of the horizontal crosstalk.

Further, because the auxiliary capacitance electrode formed in the pixel forming portion is in an independent island-shape, a common potential needs to be applied to the auxiliary capacitance electrode through the opposite electrode that is formed in the spacer. However, the area of the auxiliary capacitance electrode needs to be increased in order for the opposite electrode formed in the spacer to be in contact with the auxiliary capacitance electrode with certainty. When the area of the auxiliary capacitance electrode is increased in this manner, the area of a pixel electrode that is formed in the same conductive layer as the auxiliary capacitance electrode is decreased, and the aperture ratio of each pixel forming portion is decreased. Accordingly, there is a problem that the aperture ratio of the entire liquid crystal panel is also decreased.

It is also difficult for a contact state between the opposite electrode formed in the spacer and the auxiliary capacitance electrode to be exactly same for each pixel forming portion. Therefore, there is another problem that potential of the auxiliary capacitance electrode becomes different for each pixel formatting portion.

An object of the present invention is to provide a display panel and a display device that are capable of suppressing the occurrence of a horizontal crosstalk and ensuring the aperture ratio of the entire display panel.

### Means for Solving the Problems

A first aspect of the present invention is an active matrix system display panel, including: a first insulating substrate having a data signal line, a scan signal line, an auxiliary capacitance wiring line formed so as to intersect with the data signal line, and a plurality of first pixel forming portions; and a second insulating substrate that is disposed facing the first insulating substrate, and that has an opposite electrode formed commonly for the plurality of first pixel forming portions, wherein each of the plurality of first pixel forming portions includes: a pixel capacitance formed by a pixel electrode and the opposite electrode; and an auxiliary capacitance that is formed by an auxiliary capacitance electrode connected to the auxiliary capacitance wiring line, which is to be applied with potential synchronized with potential of the opposite electrode, and by an auxiliary opposite electrode that is disposed facing an auxiliary capacitance electrode and that is connected to the pixel electrode, and wherein the auxiliary capacitance electrode of the first pixel forming portion is further connected to the opposite electrode within the first pixel forming portion.

A second aspect of the present invention is the first aspect of the present invention, further including a plurality of second pixel forming portions formed over the first insulating substrate, wherein the opposite electrode is also formed commonly for the plurality of second pixel forming portions, and wherein each of the plurality of second pixel forming portions includes a pixel capacitance that is formed by a pixel electrode and the opposite electrode; and an auxiliary capacitance that is formed by an auxiliary capacitance electrode connected to the auxiliary capacitance wiring line, which is to be applied with potential synchronized with potential of the opposite electrode, and by an auxiliary opposite electrode that is disposed facing an auxiliary capacitance electrode and that is connected to the pixel electrode.

A third aspect of the present invention is the first aspect of the present invention, wherein the first pixel forming portion further includes a columnar spacer part that has a surface in which a part of the opposite electrode is formed, and a contact electrode that is electrically connected to the auxiliary capacitance electrode, and wherein an opposite electrode that is formed on the surface of the spacer part is in contact with the contact electrode.

A fourth aspect of the present invention is the second aspect of the present invention, wherein each of the first pixel forming portions is disposed for a predetermined number of the second pixel forming portions.

A fifth aspect of the present invention is the second aspect of the present invention, wherein the first and second pixel forming portions include a thin film transistor, and wherein the auxiliary opposite electrode is formed unitarily with a channel part of the thin film transistor.

A sixth aspect of the present invention is the second aspect of the present invention, wherein the first and second pixel forming portions include a thin film transistor, wherein the auxiliary capacitance electrode is disposed outside the scan signal line, wherein the auxiliary opposite electrode is disposed in a region that is on a lower side of the auxiliary capacitance wiring line and that is interposed between two of the data signal lines adjacent to each other, and wherein the thin film transistor is formed in a region that is interposed between the auxiliary capacitance wiring line and the scan signal line.

A seventh aspect of the present invention is the second aspect of the present invention, wherein the auxiliary opposite electrode is the pixel electrode.

An eighth aspect of the present invention is the second aspect of the present invention, wherein the auxiliary capacitance electrode is made of a part of the auxiliary capacitance wiring line.

A ninth aspect of the present invention is the second aspect of the present invention, wherein the spacer part includes a light-shielding layer that is formed so as to cover a surface opposite to a surface in contact with the auxiliary capacitance electrode.

A tenth aspect of the present invention is a display device that includes the display panel according to any one of the first to ninth aspects.

### Effects of the Invention

According to the first aspect of the present invention, provided on a display panel is a plurality of first pixel forming portions in which a pixel capacitance and an auxiliary capacitance are included, and in which an auxiliary capacitance electrode of the auxiliary capacitance is connected to an auxiliary capacitance wiring line and to an opposite electrode of the pixel capacitance. Therefore, even if potential of the auxiliary capacitance wiring line is drawn in by the parasitic capacitance at the intersection of the auxiliary capacitance wiring line and the data signal line, potential of the auxiliary capacitance electrode is quickly recovered to the original common potential. Accordingly, potential of the pixel electrode becomes insusceptible to a change in potential of the adjacent data signal line, and therefore, it is possible to suppress the occurrence of a horizontal crosstalk. Further, each auxiliary capacitance electrode is not only connected to the opposite electrode, but also to the auxiliary capacitance wiring line. This way, even if the auxiliary capacitance electrode and the opposite electrode are not well connected to each other, potential that is synchronized with the common potential is surely applied to the auxiliary capacitance electrode from the auxiliary capacitance wiring line.

According to the second aspect of the present invention, in a second pixel forming portion, the auxiliary capacitance electrode and the opposite electrode are not electrically in contact with each other, and therefore, the area of the pixel electrode can be increased. This way, the aperture ratio of the second pixel forming portion can be larger than the aperture ratio of the first pixel forming portion. As a result, by disposing the second pixel forming portion in the display panel along with the first pixel forming portion, the aperture ratio of the entire display panel can be increased.

According to the third aspect of the present invention, by having the first pixel forming portion provided with a columnar spacer part that is covered by a part of the opposite electrode, and by bringing an opposite electrode of the spacer part into contact with a contact electrode, which is electrically connected to the auxiliary capacitance electrode, the common potential can be applied to the auxiliary capacitance electrodes in all of the first pixel forming portions. This way, even if the potential of the auxiliary capacitance wiring line is drawn in, the potential of the auxiliary capacitance electrode is quickly recovered to the original common potential.

According to the fourth aspect of the present invention, the first pixel forming portion is disposed for each of a predetermined number of the second pixel forming portions, and therefore, the potential of the auxiliary capacitance wiring line drawn in can be quickly recovered to the original common potential, and the aperture ratio of the entire display panel can also be increased.

According to the fifth aspect of the present invention, because a distance between the auxiliary capacitance electrode and the auxiliary opposite electrode is small, a capacitance value of the auxiliary capacitance can be increased.

According to the sixth aspect of the present invention, the auxiliary capacitance electrode is disposed outside the scan signal line, and the auxiliary opposite electrode is disposed in a region that is on the lower side of the auxiliary capacitance wiring line and that is interposed between two adjacent data signal lines, and therefore, the area of the auxiliary opposite electrode is increased. This way, the capacitance value of the auxiliary capacitance can be increased.

According to the seventh aspect of the present invention, because a part of the pixel electrode is made into an auxiliary capacitance electrode, the area of the pixel electrode is increased. This way, the aperture ratio of the first and second pixel forming portions can be increased.

According to the eighth aspect of the present invention, because a part of the auxiliary capacitance wiring line is made into an auxiliary capacitance electrode, it is not necessary to form an auxiliary capacitance electrode other than the auxiliary capacitance wiring line. This way, the aperture ratio of the first and second pixel forming portions can be increased.

According to the ninth aspect of the present invention, a light-shielding layer covers the spacer part in its surface that is opposite to a side in contact with the auxiliary capacitance electrode. This way, it is possible to prevent external light from entering from the spacer part into the first pixel forming portion so that a view on the display panel screen is not interfered.

According to the tenth aspect of the present invention, the display device has effects of a display panel according to any one of the first to eighth aspects of the invention.

### BRIEF DESCRIPTION OF THE DRAWINGS

FIG. 1 is a block diagram showing the configuration of an active matrix system liquid crystal display device according to Embodiment 1 of the present invention.

FIG. 2 is a circuit diagram showing the configurations of pixel forming portions included in the liquid crystal panel of the liquid crystal display device shown in FIG. 1. FIG. 2(a) is a circuit diagram showing the configuration of a pixel forming portion in which an auxiliary capacitance electrode is connected to an auxiliary capacitance wiring line and an opposite electrode, and FIG. 2(b) is a circuit diagram showing the configuration of a pixel forming portion in which an auxiliary capacitance electrode is only connected to an auxiliary capacitance wiring line.

FIG. 3 is a view showing a change in potential of the auxiliary capacitance electrode at the pixel forming portion shown in FIG. 2(b) due to a parasitic capacitance at the intersection of the auxiliary capacitance wiring line and the data signal line.

FIG. 4 is a circuit diagram showing a part of the configuration of the liquid crystal panel included in the liquid crystal display device shown in FIG. 1.

FIG. 5 is a plan view showing a pattern arrangement of respective components of the pixel forming portion shown in FIG. 2(a).

FIG. 6 is a cross-sectional view along the line A-A of the pixel forming portion shown in FIG. 5.

FIG. 7 is a plan view showing a pattern arrangement of respective components of the pixel forming portion shown in FIG. 2(b).

FIG. 8 is a cross-sectional view along the line B-B of the pixel forming portion shown in FIG. 7.

FIG. 9 is a circuit diagram showing the configurations of pixel forming portions included in the liquid crystal panel of the liquid crystal display device according to Embodiment 2 of the present invention. FIG. 9(a) is a circuit diagram showing the configuration of a pixel forming portion in which an auxiliary capacitance electrode is connected to an auxiliary capacitance wiring line and an opposite electrode, and FIG. 9(b) is a circuit diagram showing the configuration of a pixel forming portion in which an auxiliary capacitance electrode is only connected to an auxiliary capacitance wiring line.

FIG. 10 is a circuit diagram showing a part of the configuration of a liquid crystal panel included in the liquid crystal display device according to Embodiment 2.

FIG. 11 is a view showing a pattern arrangement of respective components of the pixel forming portion shown in FIG. 9(a).

FIG. 12 is a cross-sectional view along the line C-C of the pixel forming portion shown in FIG. 11.

FIG. 13 is a view showing a pattern arrangement of respective components of the pixel forming portion shown in FIG. 9(b).

FIG. 14 is a cross-sectional view along the line D-D of the pixel forming portion shown in FIG. 13.

FIG. 15 is a view showing a pattern arrangement of respective components of a pixel forming portion according to Embodiment 3 in which an auxiliary capacitance electrode is connected to an auxiliary capacitance wiring line and an opposite electrode.

FIG. 16 is a cross-sectional view along the line E-E of the pixel forming portion shown in FIG. 15.

FIG. 17 is a view showing a pattern arrangement of respective components of the pixel forming portion according to Embodiment 3 in which an auxiliary capacitance electrode is only connected to an auxiliary capacitance wiring line.

FIG. 18 is a cross-sectional view along the line F-F of the pixel forming portion shown in FIG. 17.

FIG. 19 is a view showing a pattern arrangement of respective components of the pixel forming portion according to Embodiment 4 in which an auxiliary capacitance electrode is connected to an auxiliary capacitance wiring line and an opposite electrode.

FIG. 20 is a cross-sectional view along the line G-G of the pixel forming portion shown in FIG. 19.

FIG. 21 is a view showing a pattern arrangement of respective components of the pixel forming portion according to Embodiment 4 in which an auxiliary capacitance electrode is only connected to an auxiliary capacitance wiring line.

FIG. 22 is a cross-sectional view along the line H-H of the pixel forming portion shown in FIG. 21.

FIG. 23 is a view showing a change in potential of an auxiliary capacitance electrode due to a parasitic capacitance at the intersection of an auxiliary capacitance wiring line and a data signal line in a conventional pixel forming portion.

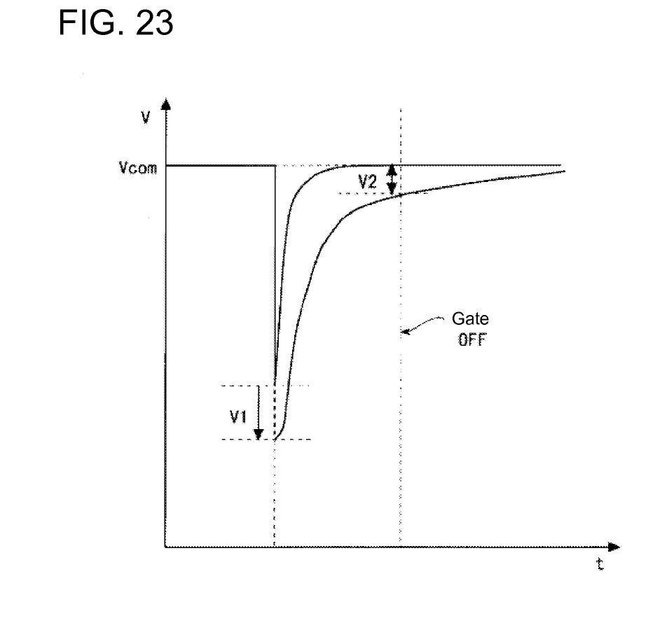

### DETAILED DESCRIPTION OF EMBODIMENTS

### 1. Embodiment 1

<1.1 Configuration of Liquid Crystal Display Device>

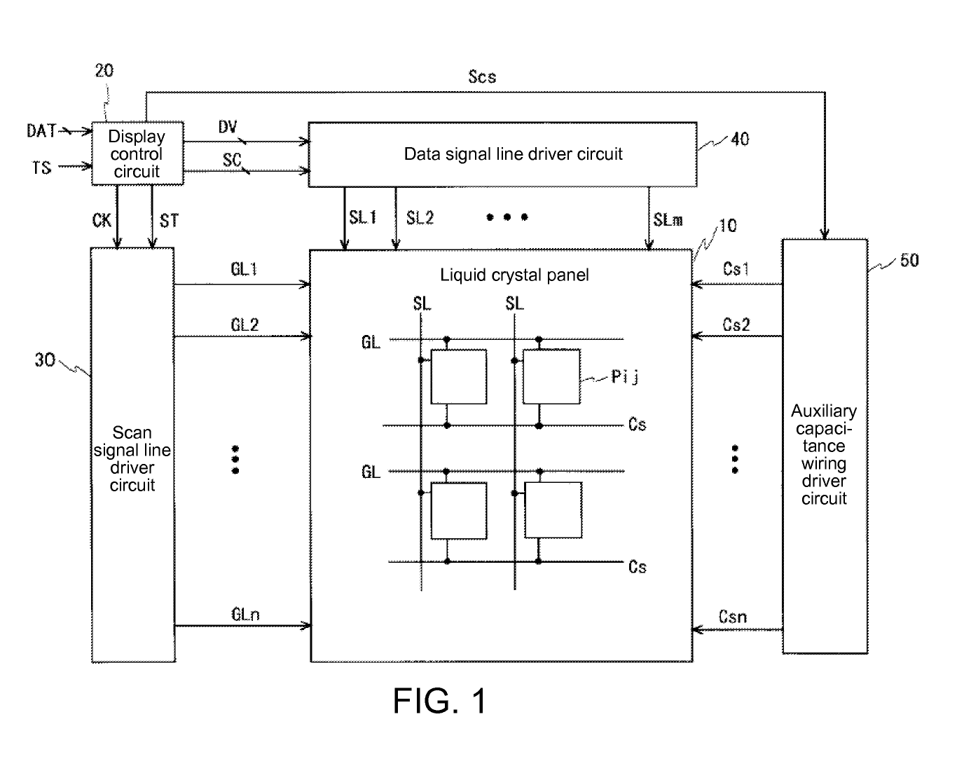

FIG. 1 is a block diagram showing the configuration of an active matrix system liquid crystal display device according to Embodiment 1 of the present invention. This liquid crystal display device is equipped with a liquid crystal panel 10, a display control circuit 20, a scan signal line driver circuit 30, a data signal line driver circuit 40, and an auxiliary capacitance wiring driver circuit 50.

The liquid crystal panel 10 includes a TFT substrate, a color filter (hereinafter referred to as “CF”) substrate, and a liquid crystal layer interposed between the TFT substrate and the CF substrate. As shown in FIG. 1, the TFT substrate includes m (m: an integer equal to or larger than 1) lines of data signal lines SL1 to SLm, n (n: an integer equal to or larger than 1) lines of scan signal lines GL1 to GLn, n lines of auxiliary capacitance wiring lines Cs1 to Csn, and (m×n) of pixel forming portions Pij. The scan signal lines GL1 to GLn are disposed in parallel with each other in a horizontal direction, the data signal lines SL1 to SLm are disposed in parallel with each other so as to be perpendicular to the scan signal lines GL1 to GLn, and each of the auxiliary capacitance wiring lines Cs1 to Csn is disposed in parallel with the scan signal lines GL1 to GLn. The pixel forming portion Pij is disposed in the proximity of the intersection of the scan signal lines GL1 to GLn and the data signal lines SL1 to SLm. As for (m×n) of the pixel forming portions Pij, m pieces of Pij are disposed in a row direction, and n pieces of Pij are disposed in a column direction in a matrix. A data signal line SLj (j: an integer equal to or larger than 1, and equal to or smaller than m) is commonly connected to the pixel forming portions Pij disposed in the “j”-th column, and a scan signal line GLi (i: an integer equal to or larger than 1, and equal to or smaller than n) and an auxiliary capacitance wiring line Csi are commonly connected to the pixel forming portions Pij disposed in the “i”-th row. The CF substrate includes an opposite electrode, which is commonly formed for a plurality of the pixel forming portions Pij, and a color filter for forming a display color.

A control signal TS such as a horizontal synchronizing signal and a vertical synchronizing signal, and a display image data DAT are supplied to the display control circuit 20 from outside. Based on these signals, the display control circuit 20 outputs a clock signal CK and a start pulse ST to the scan signal line driver circuit 30, outputs a control signal SC and a digital image signal DV to the data signal line driver circuit 40, and outputs a control signal Scs to the auxiliary capacitance wiring driver circuit 50.

The scan signal line driver circuit 30 outputs a selection signal to the scan signal lines GL1 to GLn in sequence. This way, the scan signal lines GL1 to GLn are sequentially selected one by one, and pixel circuits Pij of one row are selected at once.

The data signal line driver circuit 40 supplies voltage in accordance with the digital image signal DV to the data signal lines SL1 to SLm based on the control signal SC and the digital image signal DV. Accordingly, voltage in accordance with the digital image signal DV is written in the pixel forming portions Pij of a selected row.

The auxiliary capacitance wiring driver circuit 50 supplies potential having the same value as a common potential of the opposite electrode to the auxiliary capacitance wiring lines Cs1 to Csn by synchronizing the potential with the common potential, in order to effectively increase voltage that is applied to a liquid crystal layer within the pixel forming portions Pij when a TFT within the pixel forming portions Pij is in an off-state. Here, the potential of the opposite electrode may either be fixed or changed for each horizontal scanning period.

<1.2 Configuration of Liquid Crystal Panel>

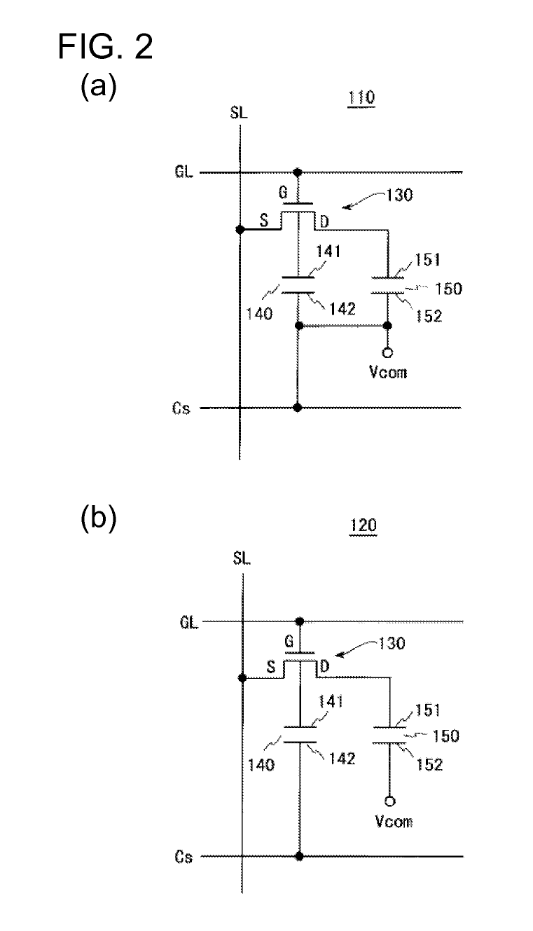

Two kinds of pixel forming portions having different connections of the auxiliary capacitance wiring line are respectively included in the liquid crystal panel 10 of the liquid crystal display device. FIG. 2 is a circuit diagram showing the configurations of the pixel forming portions included in the liquid crystal display panel 10. FIG. 2(a) is a circuit diagram showing the configuration of a pixel forming portion 110 in which an auxiliary capacitance electrode 142 is connected to the auxiliary capacitance wiring line Cs and an opposite electrode 152, and FIG. 2(b) is a circuit diagram showing the configuration of a pixel forming portion 120 in which the auxiliary capacitance electrode 142 is only connected to an auxiliary capacitance wiring line Cs.

The configuration of the pixel forming portion 110 is described by referring to FIG. 2(a). The pixel forming portion 110 includes an n-channel type TFT 130, and a gate electrode G of the TFT 130 is connected to the scan signal line GL, a source electrode S is connected to the data signal line SL, and a drain electrode D is connected to a pixel electrode 151. The pixel electrode 151 constitutes a pixel capacitance 150 along with the opposite electrode 152, which is commonly provided for a plurality of the pixel forming portions, and a liquid crystal layer, which is interposed between the pixel electrode 151 and the opposite electrode 152.

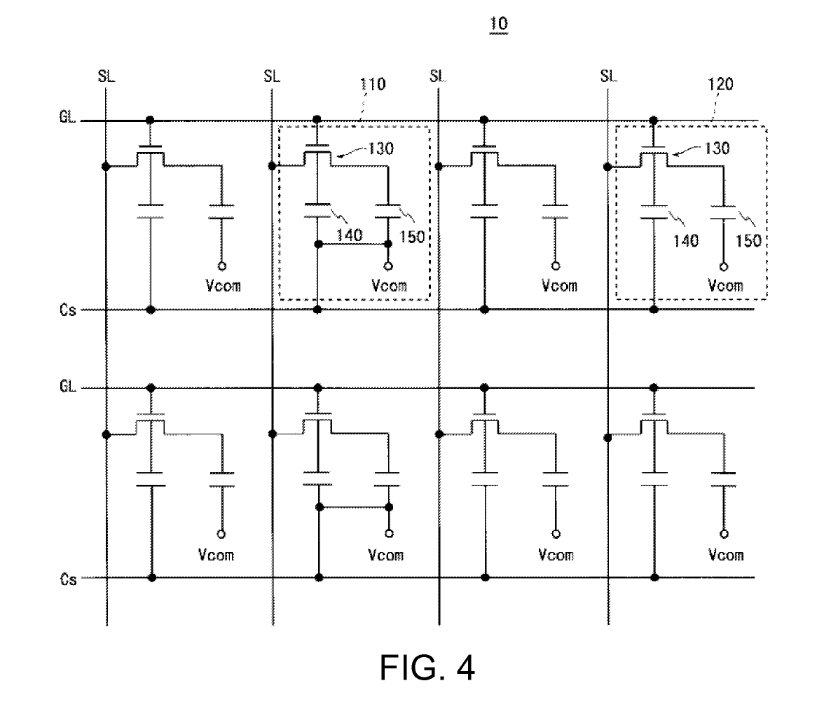

The auxiliary capacitance electrode 142 constitutes an auxiliary capacitance 140 along with an auxiliary opposite electrode 141 and an insulating film interposed therebetween. The auxiliary opposite electrode 141 is connected to a semiconductor layer that constitutes a channel part of the TFT 130 as described later. Therefore, in FIG. 2 and FIG. 4 that will be described later, for convenience, the auxiliary opposite electrode 141 is connected to the channel part of the TFT 130 in order to show that the auxiliary opposite electrode 141 is connected to the semiconductor layer that constitutes the channel part. Meanwhile, the auxiliary capacitance electrode 142 is not only connected to the auxiliary capacitance wiring line Cs, but also to the opposite electrode 152 that applies the common potential Vcom.

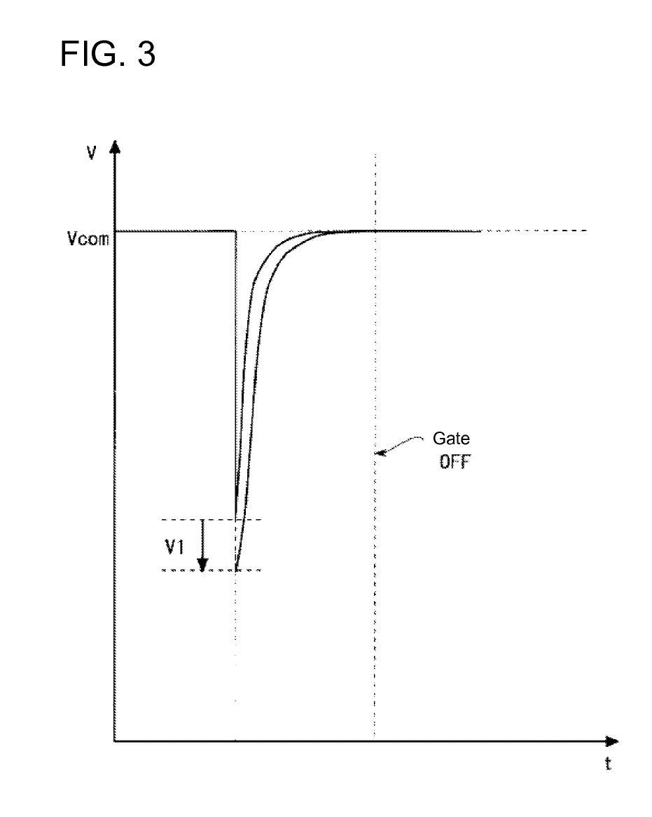

FIG. 3 is a view showing a change in the potential of the auxiliary capacitance electrode 142 in the pixel forming portion 110 due to a parasitic capacitance at the intersection of the auxiliary capacitance wiring line Cs and the data signal line SL. As shown in FIG. 3, even if the potential of the auxiliary capacitance electrode 142 in the pixel forming portion 110 is lowered by V1 compared to the original voltage because it is drawn-in by the parasitic capacitance at the intersection of the data signal line SL and the auxiliary capacitance wiring line Cs, the potential of the auxiliary capacitance electrode 142 is quickly recovered to the same potential as the common potential Vcom of the opposite electrode 152 before the gate of the TFT 130 becomes an off-state. In this way, even if the potential of the auxiliary capacitance electrode 142 is drawn in by a change in potential of the data signal line SL, because the potential of the auxiliary capacitance electrode 142 has been recovered to the common potential Vcom when the gate of the TFT 130 became an off-state, the occurrence of a horizontal crosstalk can be suppressed.

The configuration of the pixel forming portion 120 is described by referring to FIG. 2(b). In the pixel forming portion 120 shown in FIG. 2(b), components same as the ones in the pixel forming portion 110 shown in FIG. 2(a) have the same reference numbers. Unlike the pixel forming portion 110, the auxiliary capacitance electrode 142 of the pixel forming portion 120 is only connected to the auxiliary capacitance wiring line Cs, and is not connected to the opposite electrode 152. Accordingly, the common potential Vcom is applied to the auxiliary capacitance electrode Cs only by the auxiliary capacitance wiring line Cs. In this case, if the potential of the auxiliary capacitance electrode 142 in the pixel forming portion 120 were lowered by V1 compared to the original voltage because it is drawn in by the parasitic capacitance at the intersection of the data signal line SL and the auxiliary capacitance wiring line Cs, the potential of the auxiliary capacitance electrode 142 would not have been recovered to the same potential as the common potential Vcom of the opposite electrode 152 when the gate of the TFT 130 becomes an off-state. Here, a connection between the TFT130 and the pixel capacitance 150 is same as that in the pixel forming portion 110, and therefore, the description is omitted.

Described next is the configuration of the liquid crystal panel 10 in which these pixel forming portions 110 and 120 are disposed. FIG. 4 is a circuit diagram showing a part of the configuration of the liquid crystal panel 10. As shown in FIG. 4, on the liquid crystal panel 10, each of the pixel forming portions 110 is disposed for a predetermined number of the pixel forming portions 120. A reason for arranging the pixel forming portions 110 and 120 in this manner will be described later. As a result of arranging the pixel forming portions 110 and 120 in this manner, it is possible, in the pixel forming portion 120 as well, to recover the potential of the auxiliary capacitance electrode 142 to the same potential as the common potential Vcom of the opposite electrode 152 before the gate of the TFT 130 becomes an off-state.

<1.3 Pattern Arrangement of Pixel Forming Portion>

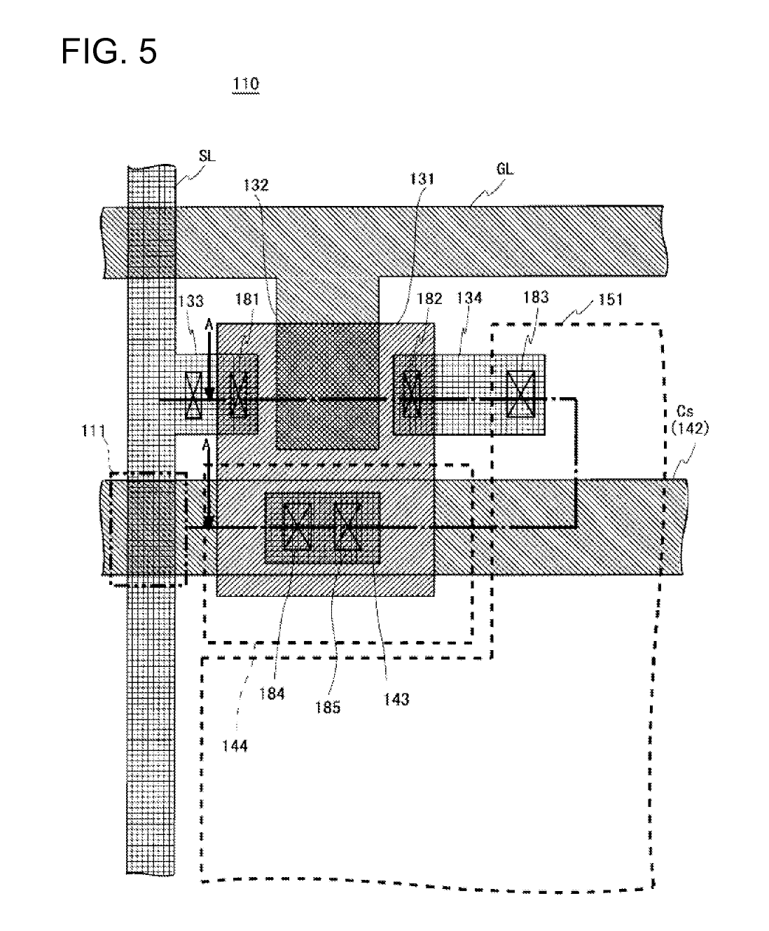

Described next is the pattern arrangements of the pixel forming portion 110 and the pixel forming portion 120. These pattern arrangements are arrangements that are often suited for a pixel forming portion including an amorphous silicon TFT. FIG. 5 is a plan view showing the pattern arrangement of respective components of the pixel forming portion 110 shown in FIG. 2(a). As shown in FIG. 5, a gate electrode 132 extending from the scan signal line GL is disposed in a center part over a semiconductor layer 131, which is to be a channel part of the TFT, a source electrode 133 extending from the data signal line SL is disposed on a side close to the data signal line SL (the left side in FIG. 5), and a drain electrode 134 is disposed on the opposite side (the right side in FIG. 5) across the gate electrode 132. The source electrode 133 and the drain electrode 134 are connected to the semiconductor layer 131 through contact holes 181 and 182, respectively. Moreover, the drain electrode 134 is connected to the pixel electrode 151 through a through-hole 183.

On the upper side of the semiconductor layer 131, the auxiliary capacitance wiring line Cs, a part of which functions as the auxiliary capacitance electrode 142, is disposed in parallel with the scan signal line GL such that it does not overlap the gate electrode 132. Potential of the auxiliary capacitance wiring line Cs is affected by a parasitic capacitance that occurs at an intersection 111 of the auxiliary capacitance wiring line Cs and the data signal line SL. Potential that has the same value as the common potential of the opposite electrode is applied to the auxiliary capacitance wiring line Cs from the auxiliary capacitance wiring driver circuit, but the auxiliary capacitance wiring line Cs is further applied with the common potential directly by the opposite electrode as well. Disposed on the upper side of the auxiliary capacitance wiring line Cs, in order to apply the common potential to the auxiliary capacitance wiring line Cs from the opposite electrode, are an intermediate pad 143 that is connected to the auxiliary capacitance wiring line Cs through a contact hole 184, and a contact pad 144 that is connected to the intermediate pad 143 through a through-hole 185. This way, when the opposite electrode comes in contact with the contact pad 144, the common potential that is applied to the opposite electrode is supplied to the auxiliary capacitance wiring line Cs through the contact pad 144 and the intermediate pad 143. As a result, when voltage in accordance with a digital image signal is applied to the semiconductor layer 131 from the data signal line SL through the TFT, the applied voltage is kept in an auxiliary capacitance that is constituted of the semiconductor layer 131, the auxiliary capacitance wiring line Cs, and an insulating film interposed therebetween.

Further, an insulating film of the auxiliary capacitance is a gate insulating film only, which is interposed between the semiconductor layer 131 and the auxiliary capacitance electrode 142, and therefore, the capacitance value of the auxiliary capacitance can be increased. In the pixel forming portion 110, a part of the auxiliary capacitance wiring line Cs facing the semiconductor layer 131 functions as an auxiliary capacitance electrode 142, but an auxiliary capacitance electrode 142 may also be formed separately from the auxiliary capacitance wiring line Cs, and may be connected to the auxiliary capacitance wiring line Cs.

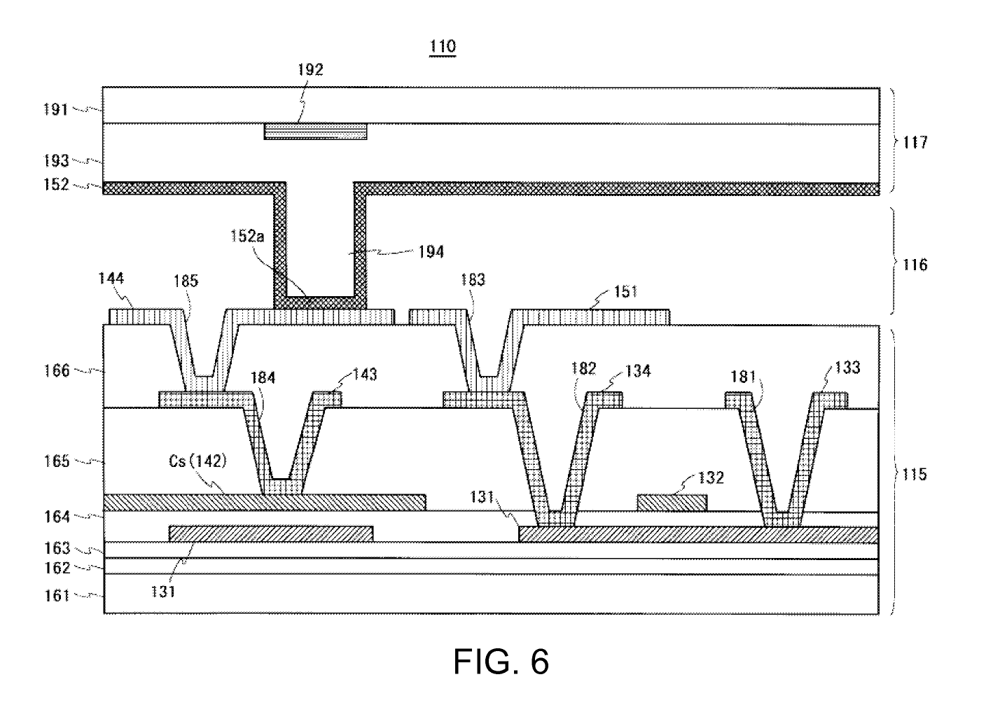

FIG. 6 is a cross-sectional view along the line A-A of the pixel forming portion 110 shown in FIG. 5. As shown in FIG. 6, in a TFT substrate 115, on a surface of a glass substrate 161, which is an insulating substrate, a first basecoat film 162 made of SiN (silicon nitride film) or the like, for example, which has a function of preventing mobile ions such as Na⁺ (sodium ion) from penetrating from the glass substrate 161, is formed. Moreover, laminated on a surface of the first basecoat film 162 is a second basecoat film 163 made of SiO₂ (silicon oxide) film or the like, for example, which is not likely to form interface states at an interface with the semiconductor layer, which will be described later.

Formed on a surface of the second basecoat film 163 is a semiconductor layer 131 that is made of an amorphous silicon film, for example, and functions as a channel part of the TFT and an auxiliary opposite electrode of the auxiliary capacitance. Furthermore, a gate insulating film 164 made of a SiO₂ film or the like, for example, is formed so as to cover the semiconductor layer 131.

Formed on a surface of the gate insulating film 164 are a gate electrode 132, which is made of a metal film such as Mo (molybdenum), Ta (tantalum), Cr (chrome) or the like, or made of a multilayer film of them, and the auxiliary capacitance wiring line Cs, a part of which functions as the auxiliary capacitance electrode 142. Further, an interlayer insulating film 165 made of a SiN film or a SiO₂ film, for example, is formed so as to cover the gate electrode 132 and the auxiliary capacitance wiring line Cs. In the interlayer insulating film 165, a contact hole 184 that reaches the auxiliary capacitance wiring line Cs is formed, and two contact holes 181 and 182 that respectively reach the semiconductor layer 131 are formed with the gate electrode 132 inbetween.

Formed on the interlayer insulating film 165 are the intermediate pad 143 that is electrically connected to the auxiliary capacitance wiring line Cs through the contact hole 184, and the source electrode 133 and the drain electrode 134 that are electrically connected to the semiconductor layer 131 through the contact holes 181 and 182, respectively. All of the intermediate pad 143, the source electrode 133, and the drain electrode 134 are made of a metal film such as Mo, Ta, or Cr, a multilayer film made of those, or a multilayer film in which a Ti (titanium) film, an Al (aluminum) film, and a Ti film are laminated in order, for example.

A resin film 166, which is made of an acrylic resin or the like, for example, and which planarizes a surface, is formed so as to cover the intermediate pad 143, the source electrode 133, and the drain electrode 134. In the resin film 166, through-holes 183 and 185 that reach the drain electrode 134 and the intermediate pad 143, respectively, are formed. Formed on a surface of the resin film 166 are a pixel electrode 151 and a contact pad 144, which are made of a transparent metal such as ITO (Indium Tin Oxide), for example. The pixel electrode 151 is electrically connected to the drain electrode 134 through the through-hole 183. The contact pad 144 is electrically connected to the intermediate pad 143 through the through-hole 185. This contact pad 144 and the pixel electrode 151 are formed apart from each other so that different potentials can be applied.

Described next is a CF substrate 117 that is disposed facing the TFT substrate 115 through a liquid crystal layer 116. The CF substrate 117 includes a glass substrate 191, which is a transparent insulating substrate, and a color filter layer 193 is formed on a surface of the glass substrate 191 (a bottom surface in FIG. 6). The color filter layer 193 is a colored layer of one of red, green, and blue colored layers, and these respective colored layers are arranged in a predetermined order to correspond to respective pixel forming portions. At a position facing the contact pad 144, a protruding columnar spacer 194 called a photo spacer, which is made of a resin such as acrylic resin, is disposed for maintaining a predetermined distance between the TFT substrate 115 and the CF substrate 117.

On a surface of the color filter layer 193, and also on side surfaces and a bottom surface (a surface in contact with the contact pad 144) of the spacer 194, an opposite electrode 152 made of a transparent metal such as ITO is formed. The opposite electrode 152 is formed commonly for a plurality of the pixel forming portions, and is applied with the common potential. Because an opposite electrode 152a, which is formed at the bottom surface of the spacer 194, of the opposite electrode 152 is in contact with the contact pad 144, the opposite electrode 152 is electrically connected to the auxiliary capacitance wiring line Cs through the contact pad 144 and the intermediate pad 143. Therefore, the common potential that is applied to the opposite electrode 152 is also supplied to the auxiliary capacitance wiring line Cs through the spacer 194. Furthermore, on a surface of the glass substrate 191 (the bottom surface in FIG. 6) corresponding to the spacer 194, a light-shielding layer 192 called a black matrix is formed in order to block external light and to prevent a visibility problem on the screen.

Formed on a surface of the pixel electrode 151 and on a surface of the opposite electrode 152 is an alignment film (not shown in the figure), which is made of polyimide and which has undergone an alignment treatment called a rubbing in order to align liquid crystal molecules in predetermined directions. Moreover, a polarizing plate (not shown in the figure) is attached to the outer surface of the glass substrates 161 and 191, respectively.

In this pixel forming portion 110, even if the potential of the auxiliary capacitance wiring line Cs is drawn in because of a change in voltage in accordance with a digital image signal applied to the data signal line SL, affecting the potential of the auxiliary capacitance wiring line Cs through the parasitic capacitance at the intersection 111 of the auxiliary capacitance wiring line Cs and the data signal line SL, the potential of the auxiliary capacitance wiring line Cs is quickly recovered to the common potential, and therefore, it is possible to suppress the occurrence of a horizontal crosstalk.

Meanwhile, the pixel forming portion 110 has the following problem. In order to apply the common potential to the auxiliary capacitance wiring line Cs of the pixel forming portion 110, it is necessary for the opposite electrode 152a, which is formed at the bottom surface of the spacer 194, to be in contact with the contact pad 144 with certainty. Therefore, the area of the contact pad 144 needs to be increased in consideration of a misalignment or the like during the pattern formation of the contact pad 144 and the spacer 194. However, if the area of the contact pad 144 is increased, the area of the pixel electrode 151, which is formed in the same conductive layer as the contact pad 144, is decreased, and the aperture ratio of the pixel forming portion 110 becomes smaller. Accordingly, if only the pixel forming portions 110 are provided on the liquid crystal panel 10, although it would be possible to maintain the potential of the auxiliary capacitance wiring line Cs to the common potential in all pixel forming portions despite voltage changes due to a digital image signal, this would cause a problem that the aperture ratio of the entire liquid crystal panel 10 becomes smaller.

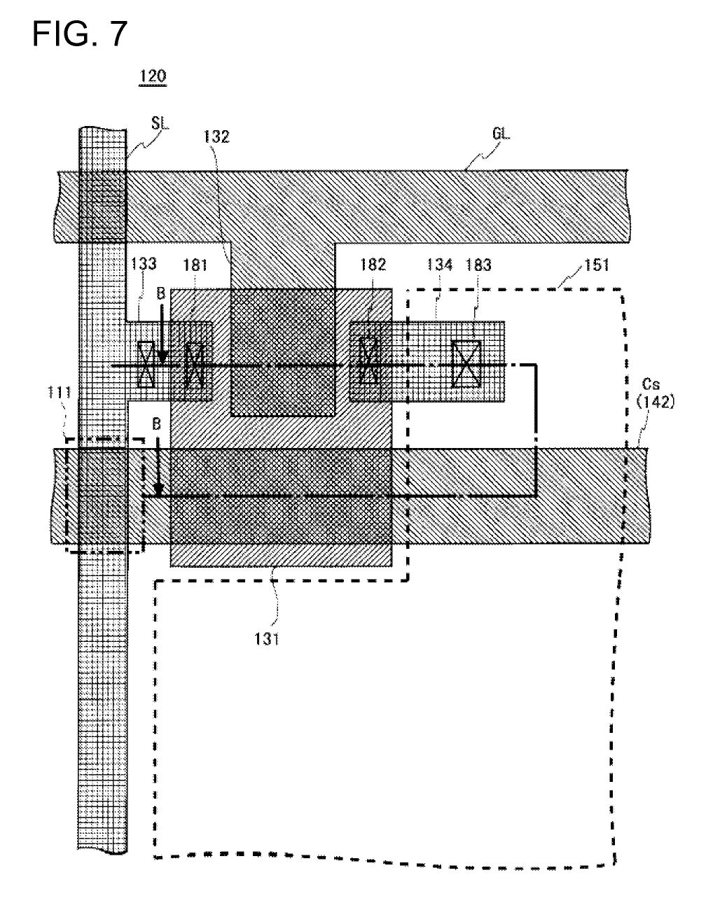

Described next is a pattern arrangement of respective components of the pixel forming portion 120 shown in FIG. 2(b). FIG. 7 is a plan view showing the pattern arrangement of respective components of the pixel forming portion 120 shown in FIG. 2(b). Here, in the pixel forming portion 120, components same as the ones in the pixel forming portion 110 shown in FIG. 5 have the same reference numbers.

As shown in FIG. 2(b), in the pixel forming portion 120, the auxiliary capacitance wiring line Cs is not connected to the opposite electrode unlike the pixel forming portion 110. Therefore, as shown in FIG. 7, the contact pad and the intermediate pad, which are formed in the pixel forming portion 110, are not formed in the pixel forming portion 120. Accordingly, the potential of the auxiliary capacitance wiring line Cs is determined only by potential applied by the auxiliary capacitance wiring driver circuit 50. Here, the pattern arrangement of the components constituting the TFT is same as the pattern arrangement of the components constituting the TFT shown in FIG. 5, and therefore, the description is omitted.

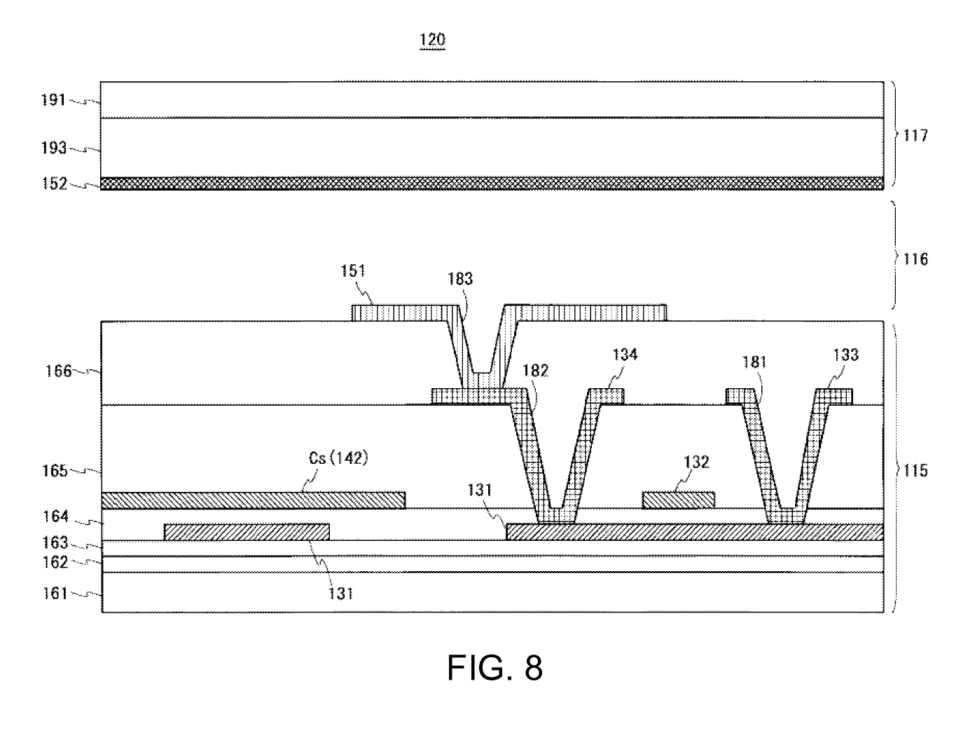

FIG. 8 is a cross-sectional view along the line B-B of the pixel forming portion 120 shown in FIG. 7. Here, in the pixel forming portion 120, components same as the ones in the pixel forming portion 110 shown in FIG. 6 have the same reference numbers.

As described above, unlike the pixel forming portion 110, a spacer is not formed in the pixel forming portion 120, and therefore, the intermediate pad 143 and the contact pad 144, which are formed in the pixel forming portion 110, become unnecessary. Accordingly, the pixel forming portion 120 does not include the contact hole formed on the auxiliary capacitance wiring line Cs, the intermediate pad formed to cover the contact hole, the through-hole formed on the intermediate pad, or the contact pad formed to cover the through-hole. Here, the arrangement of TFT components is same as the arrangement of the TFT components shown in FIG. 6, and therefore, the description is omitted.

Thus, because it is unnecessary to form a contact pad in the pixel forming portion 120, the pixel electrode 151 of the pixel forming portion 120 can be larger than the pixel electrode 151 of the pixel forming portion 110. Therefore, the aperture ratio of the pixel forming portion 120 can be made larger than the aperture ratio of the pixel forming portion 110.

Meanwhile, the pixel forming portion 120 has the following problem. Potential of the auxiliary capacitance wiring line Cs is determined only by potential applied by the auxiliary capacitance wiring driver circuit. Accordingly, a change in voltage in accordance with a digital image signal applied to the data signal line SL affects potential of the auxiliary capacitance wiring line Cs through the parasitic capacitance at the intersection 111 of the auxiliary capacitance wiring line Cs and the data signal line SL, and therefore, the potential of the auxiliary capacitance wiring line Cs is drawn in, thereby creating a problem that a horizontal crosstalk is likely to occur. In this case, because potential is applied to the auxiliary capacitance wiring line Cs from the side end thereof, the potential of the auxiliary capacitance wiring line Cs becomes progressively lower with the distance from the potential application point. Therefore, time it takes for the potential of the auxiliary capacitance wiring line Cs, which has been drawn in by the parasitic capacitance, to recover to the same potential as the common potential also becomes progressively longer with the distance from the application point. As a result, voltage applied to the liquid crystal layer 116 also becomes smaller in accordance with the distance from the application point, and therefore, a belt-like shaped bright region and dark region appear on the screen.

<1.4 Effects>

As described above, because the auxiliary capacitance wiring line Cs of the pixel forming portion 110 is connected to the opposite electrode 152, the auxiliary capacitance wiring line Cs of the pixel forming portion 110 is applied with the common potential Vcom not only from the auxiliary capacitance wiring driver circuit 50, but also from the opposite electrode 152. Therefore, even if the potential of the auxiliary capacitance wiring line Cs is drawn in because a change in voltage in accordance with a digital image signal applied to the data signal line SL affects the potential of the auxiliary capacitance wiring line Cs through the parasitic capacitance at the intersection 111 of the auxiliary capacitance wiring line Cs and the data signal line SL, the potential of the auxiliary capacitance wiring line Cs is quickly recovered to the original common potential Vcom before the gate of the TFT 130 becomes an off-state. Accordingly, at the pixel forming portion 110, potential of the pixel electrode 151 becomes insusceptible to a change in potential of the adjacent data signal line SL, and the occurrence of a horizontal crosstalk can be suppressed.

The pixel electrode 151 of the pixel forming portion 120 can be made larger than the pixel electrode 151 of the pixel forming portion 110. Thus, the aperture ratio of the pixel forming portion 120 can be made larger than the aperture ratio of the pixel forming portion 110.

Further, it is difficult for the contact condition between the opposite electrode 152a, which is formed at the bottom surface of the spacer 194, and the contact pad 144 to be exactly the same for each pixel forming portion 110. Accordingly, the common potential Vcom that is applied from the opposite electrode 152 through the opposite electrode 152a, which is formed at the bottom surface of the spacer 194, may become different for each pixel forming portion 110. Therefore, in the liquid crystal panel 10, by also applying the common potential Vcom to the auxiliary capacitance wiring line Cs from the auxiliary capacitance wiring driver circuit 50, it is possible to suppress the difference of the common potential Vcom applied through the spacer 194.

Also, as shown in FIG. 4, in the liquid crystal panel 10 in which each of the pixel forming portions 110 is disposed for a predetermined number of the pixel forming portions 120, problems of the pixel forming portions 110 can be compensated by the pixel forming portions 120, and problems of the pixel forming portions 120 can be compensated by the pixel forming portions 110. As a result, the aperture ratio can be further increased while suppressing the occurrence of a horizontal crosstalk in the liquid crystal panel 10.

### 2. Embodiment 2

<2.1 Configuration of Liquid Crystal Panel>

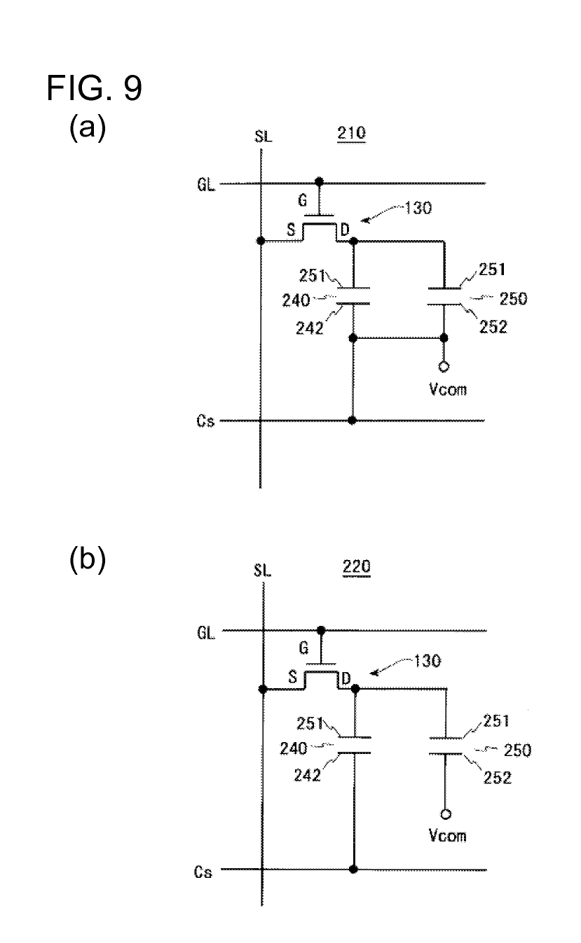

A liquid crystal display device of Embodiment 2 is the same as the liquid crystal display device shown in FIG. 1, and therefore, the description is omitted. FIG. 9 is a circuit diagram showing the configuration of pixel forming portions included in a liquid crystal panel 11 of the liquid crystal display device according to Embodiment 2 of the present invention. FIG. 9(a) is a circuit diagram showing the configuration of a pixel forming portion 210 in which an auxiliary capacitance electrode 242 is connected to the auxiliary capacitance wiring line Cs and an opposite electrode 252, and FIG. 9(b) is a circuit diagram showing the configuration of a pixel forming portion 220 in which the auxiliary capacitance electrode 242 is only connected to the auxiliary capacitance wiring line Cs.

In the pixel forming portions 210 and 220 of Embodiment 2, unlike the pixel forming portions 110 and 120 of Embodiment 1 shown in FIG. 2, an auxiliary capacitance 240 is constituted of the auxiliary capacitance electrode 242, a pixel electrode 251, and an insulating film interposed therebetween.

The configuration of the pixel forming portion 210 is described by referring to FIG. 9(a). The pixel forming portion 210 includes the n-channel type TFT 130, and a gate electrode G of the TFT 130 is connected to the scan signal line GL, a source electrode S is connected to the data signal line SL, and a drain electrode D is connected to the pixel electrodes 251. The pixel electrode 251 constitutes a pixel capacitance 250 along with the opposite electrode 252, which is commonly formed for a plurality of the pixel forming portions, and a liquid crystal layer interposed between the pixel electrode 251 and the opposite electrode 252.

The auxiliary capacitance electrode 242 constitutes the auxiliary capacitance 240 along with the pixel electrode 251 and an insulating film interposed between the auxiliary capacitance electrode 242 and the pixel electrode 251. Further, the auxiliary capacitance electrode 242 is connected to the auxiliary capacitance wiring line Cs and also to the opposite electrode 252, which applies the common potential Vcom.

The configuration of the pixel forming portion 220 is described by referring to FIG. 9(b). In the pixel forming portion 220 shown in FIG. 9(b), components same as the ones in the pixel forming portion 210 shown in FIG. 9(a) have the same reference numbers. As shown in FIG. 9(b), unlike the auxiliary capacitance electrode 242 of the pixel forming portion 210, the auxiliary capacitance electrode 242 of the pixel forming portion 220 is only connected to the auxiliary capacitance wiring line Cs, and is not connected to the opposite electrode 252. Therefore, the common potential Vcom of the opposite electrode 252 is not applied to the auxiliary capacitance electrode 242. In this case, if potential of the auxiliary capacitance electrode 242 in the pixel forming portion 220 is lowered because it is drawn in by a parasitic capacitance at the intersection of the data signal line SL and the auxiliary capacitance wiring line Cs, the potential of the auxiliary capacitance electrode 242 has not been recovered to the same potential as the common potential Vcom of the opposite electrode 252 when the gate of the TFT 130 became an off-state. Here, the TFT 130 and the pixel capacitance 250 are the same as the ones in the pixel forming portion 210, and therefore, the description is omitted.

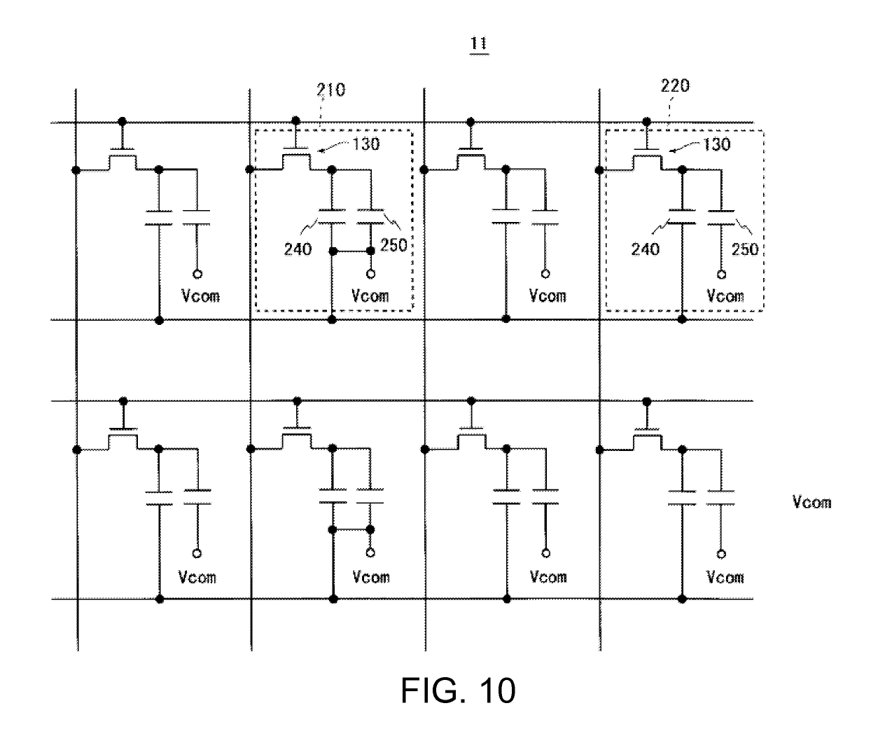

Described next is the configuration of the liquid crystal panel 11 in which these pixel forming portions 210 and 220 are disposed. FIG. 10 is a circuit diagram showing a part of the configuration of the liquid crystal panel 11 included in the liquid crystal display device of Embodiment 2. As shown in FIG. 10, on the liquid crystal panel 11, each of the pixel forming portions 210 is disposed for a predetermined number of the pixel forming portions 220. Accordingly, as a result of disposing the pixel forming portions 210 and 220 in this manner, for the same reason as in Embodiment 1, the potential of the auxiliary capacitance electrode 242 can be recovered to the same potential as the common potential Vcom of the opposite electrode 252 before the gate of the TFT 130 becomes an off-state in the pixel forming portions 220 as well.

<2.2 Patten Arrangements of Pixel Forming Portions>

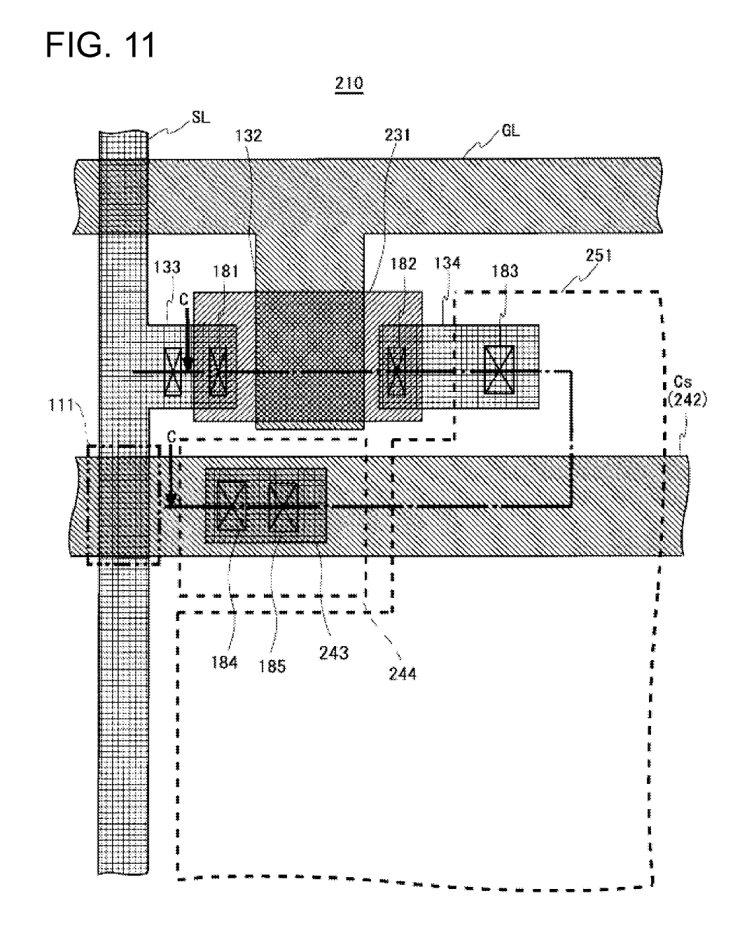

Described next is the pattern arrangements of the pixel forming portion 210 and the pixel forming portion 220. These pattern arrangements are arrangements often suited for a pixel forming portion including an amorphous silicon TFT as in the case of the pixel forming portion 110 and the pixel forming portion 220 of Embodiment 1. FIG. 11 is a view showing a pattern arrangement of respective components of the pixel forming portion 210 shown in FIG. 9(a). As shown in FIG. 11, the pattern arrangement of the TFT is the same as the pattern arrangement of the TFT in the pixel forming portion 110 shown in FIG. 5, and therefore, the description is omitted. The auxiliary capacitance wiring line Cs, a part of which functions as the auxiliary capacitance electrode 242, is disposed in parallel with the scan signal line GL. However, unlike the pixel forming portion 110, a semiconductor layer 231, which is to be a channel part of the TFT, does not extend to the lower side of the auxiliary capacitance wiring line Cs.

Moreover, in order to apply the common potential to the auxiliary capacitance wiring line Cs, in a manner similar to that of the pixel forming portion 110, an intermediate pad 243 that is connected to the auxiliary capacitance wiring line Cs through the contact hole 184, and a contact pad 244 that is connected to the intermediate pad 243 through the through-hole 185 are disposed over the auxiliary capacitance wiring line Cs. Accordingly, when the opposite electrode is in contact with the contact pad 244, the common potential is applied to the auxiliary capacitance wiring line Cs through the contact pad 244 and the intermediate pad 243 from the opposite electrode as well.

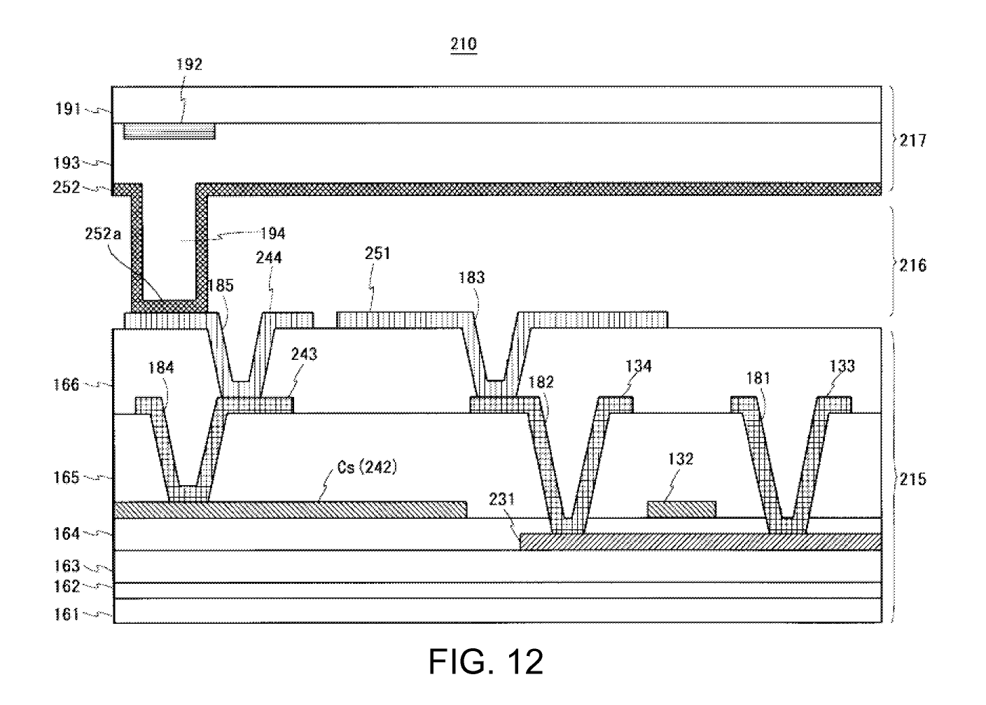

FIG. 12 is a cross-sectional view along the line C-C of the pixel forming portion 210 shown in FIG. 11. Here, in the pixel forming portion 210 shown in FIG. 12, components same as the ones in the pixel forming portion 110 shown in FIG. 6 have the same reference numbers.

As shown in FIG. 12, in the pixel forming portion 210, the semiconductor layer 231 formed on the TFT substrate 215 is only formed in a channel region of the TFT, and does not extend to the lower side of the auxiliary capacitance wiring line Cs unlike the pixel forming portion 110. Further, in order to apply the common potential to the auxiliary capacitance wiring line Cs from the spacer 194 formed in the CF substrate 217, the contact pad 244 that is in contact with an opposite electrode 252a formed at the bottom surface of the spacer 194, and the intermediate pad 243 that is connected to the contact pad 244 are formed. The auxiliary capacitance wiring line Cs, which also functions as the auxiliary capacitance electrode 242, is disposed so as to face a part of the pixel electrode 251 through the interlayer insulating film 165 and the resin film 166. Thus, in the pixel forming portion 210, an auxiliary capacitance is constituted of the auxiliary capacitance wiring line Cs, the pixel electrode 251, and the interlayer insulating film 165 as well as the resin film 166 interposed therebetween. A liquid crystal layer 216 is interposed between the TFT substrate 215 and the CF substrate 217.

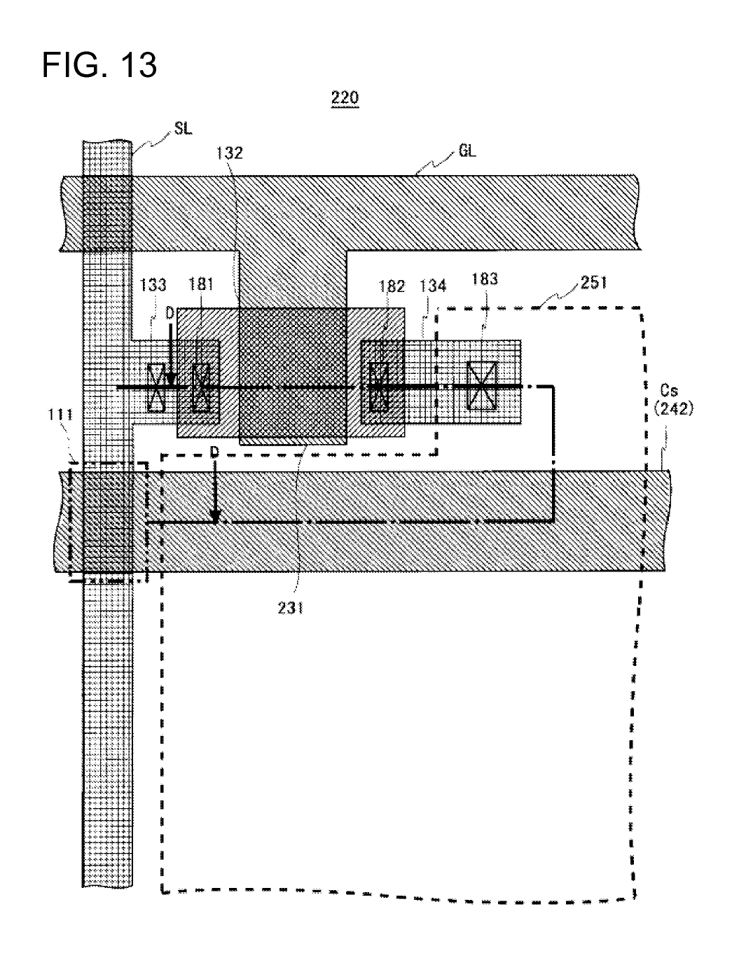

Next, the pattern arrangement of the pixel forming portion 220 is described. FIG. 13 is a view showing the pattern arrangement of respective components of the pixel forming portion 220 shown in FIG. 9(b). Here, in the pixel forming portion 220 shown in FIG. 13, components same as the ones in the pixel forming portion 210 shown in FIG. 11 have the same reference numbers.

As shown in FIG. 9(b), in the pixel forming portion 220, the auxiliary capacitance wiring line Cs is not electrically connected to the opposite electrode 252 unlike the pixel forming portion 210 shown in FIG. 9(a). Therefore, as shown in FIG. 13, the contact pad that is electrically in contact with the opposite electrode formed on a surface of the spacer, and the intermediate pad that is electrically connected to the contact pad, which are formed in the pixel forming portion 210, are not formed. Thus, potential of the auxiliary capacitance wiring line Cs is determined only by potential applied from the auxiliary capacitance wiring driver circuit. Here, the pattern arrangement of components constituting the TFT is same as the pattern arrangement of the TFT shown in FIG. 11, and therefore, the description is omitted.

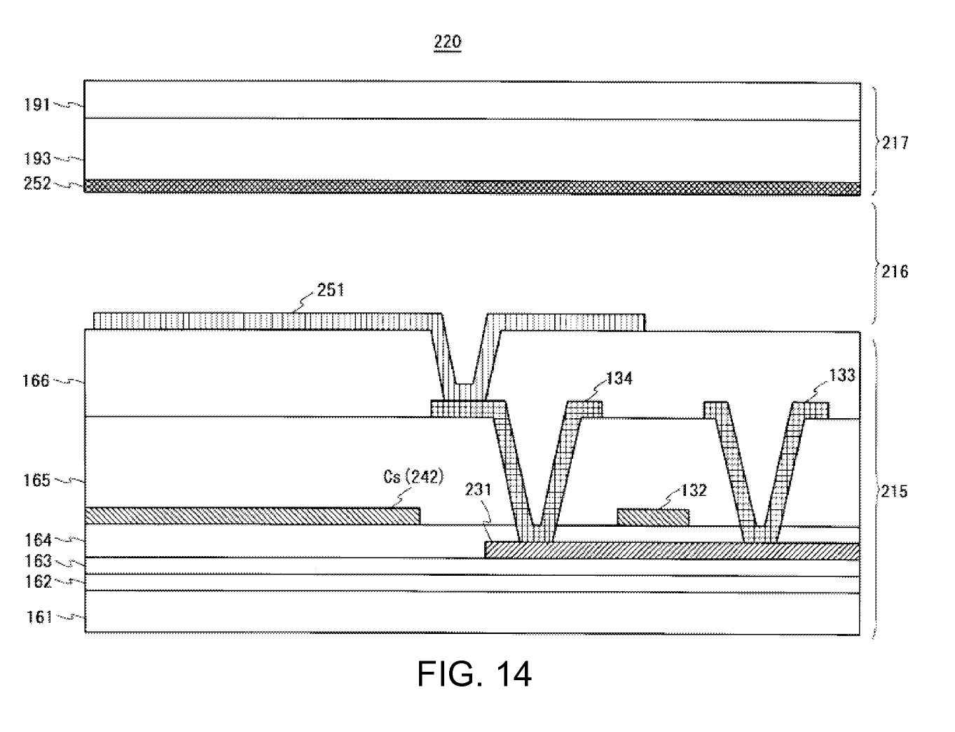

FIG. 14 is a cross-sectional view along the line D-D of the pixel forming portion 220 shown in FIG. 13. As shown in FIG. 14, in the pixel forming portion 220, components same as the ones in the pixel forming portion 210 shown in FIG. 12 have the same reference numbers. As described above, unlike the pixel forming portion 210, the spacer is not formed in the pixel forming portion 220, and therefore, the intermediate pad 243 and the contact pad 244, which are formed in the pixel forming portion 210, become unnecessary. Accordingly, as shown in FIG. 14, the pixel forming portion 220 does not include the contact hole formed on the auxiliary capacitance wiring line Cs, the intermediate pad formed to cover the contact hole, the through-hole formed on the intermediate pad, or the contact pad formed so as to cover the through-hole. Here, the arrangement of components constituting the TFT is same as the arrangement of the components of the TFT shown in FIG. 12, and therefore, the description is omitted.

<2.3 Effects>

As shown in the description above, the pixel forming portion 210 has the same effect as the pixel forming portion 110 of Embodiment 1, and the pixel forming portion 220 has the same effect as the pixel forming portion 120 of Embodiment 1. Further, each of the pixel forming portions 210 is disposed for a predetermined number of the pixel forming portions 220 in the liquid crystal panel 11 of the present embodiment, and therefore, the same effects as the liquid crystal panel 10 of Embodiment 1 are achieved. Thus, the detailed description of those effects is omitted.

### 3. Embodiment 3

The configuration of a liquid crystal display device of Embodiment 3 is same as the liquid crystal display device shown in FIG. 1; the circuit diagrams of pixel forming portions 310 and 320 included in the liquid crystal panel of the present embodiment are same as the circuit diagram of the pixel forming portion 110 shown in FIG. 2(a) and the circuit diagram of the pixel forming portion 120 shown in FIG. 2(b), respectively; and the arrangement of the pixel forming portions 310 and 320 in the liquid crystal panel is same as the arrangement of the pixel forming portions 110 and 120 shown in FIG. 4. Therefore, their description is omitted.

<3.1 Pattern Arrangement of Pixel Forming Portions>

Described next is the pattern arrangements of the pixel forming portion 310 and the pixel forming portion 320. Unlike the pixel forming portion 110 and the pixel forming portion 120 of Embodiment 1, these pattern arrangements are arrangements often suited for a pixel forming portion including a polycrystalline silicon TFT.

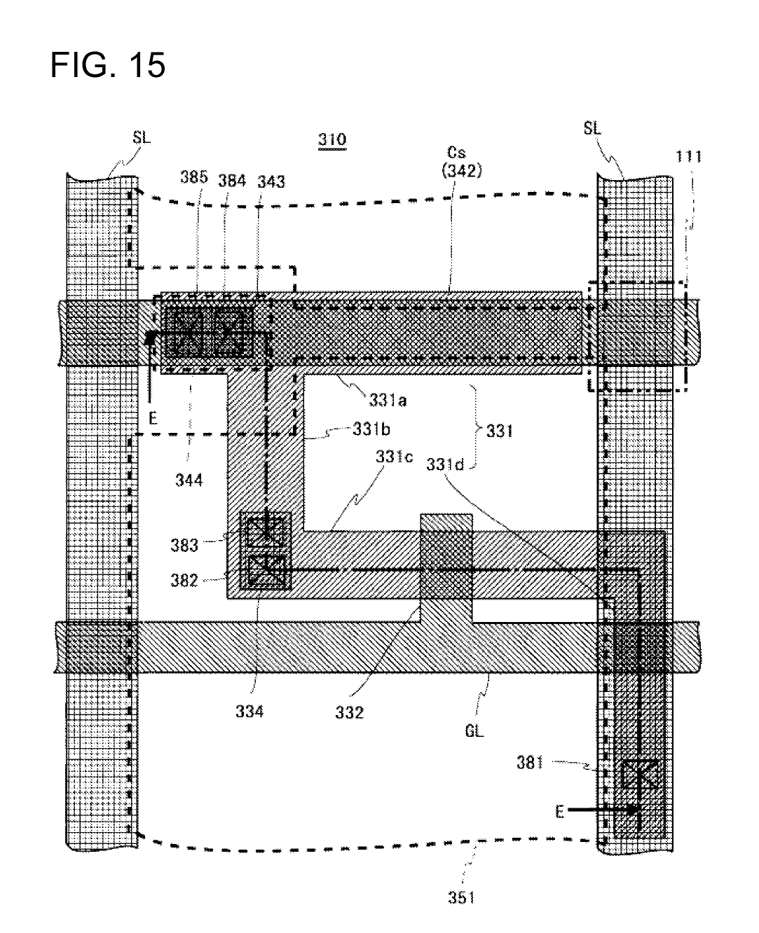

FIG. 15 is a view showing the pattern arrangement of respective components of the pixel forming portion 310. As shown in FIG. 15, the data signal lines SL are disposed in parallel with each other, and the scan signal line GL is disposed so as to intersect the data signal lines SL at a right angle. Here, among the data signal lines SL, a data signal line SL shown on the left side in FIG. 15 is the data signal line of a neighboring pixel forming portion on the left (not shown in the figure).

The auxiliary capacitance wiring line Cs is disposed in a place that is further outside (the upper side in FIG. 15) of the scan signal line GL so as to be parallel with the scan signal line GL, and is formed in the same conductive layer as the scan signal line GL.

The semiconductor layer 331 is constituted of four conductive parts that are a first conductive part 331a to a fourth conductive part 331d. The first conductive part 331a to the fourth conductive part 331d are unitarily formed so that the first conductive part 331a and the second conductive part 331b, the second conductive part 331b and the third conductive part 331c, and the third conductive part 331c and the fourth conductive part 331d are electrically connected, respectively.

The first conductive part 331a is disposed in a region that is under the auxiliary wiring capacitance Cs and that is between the two adjacent data signal lines SL so as to be parallel with the auxiliary capacitance wiring line Cs. The third conductive part 331c is disposed in a region between the auxiliary capacitance wiring line Cs and the scan signal line GL so as to be parallel with the scan signal line GL. The second conductive part 331b is disposed in a region between the auxiliary capacitance wiring line Cs and the scan signal line GL so as to connect the first conductive part 331a and the third conductive part 331c. The fourth conductive part 331d is disposed under the data signal line SL shown on the right side in FIG. 15 so as to be parallel with the data signal lines SL.

The third conductive part 331c functions as a channel part of the TFT, and a gate electrode 332 extending from the scan signal line GL is disposed on the top center of the third conductive part 331c. In the third conductive part 331c, a region on the right side of the gate electrode 332 becomes a source region of the TFT, and a region on the left side of the gate electrode 332 becomes a drain region. The source region of the TFT is connected to one end of the fourth conductive part 331d, and the other end of the fourth conductive part 331d is electrically connected to a data signal line SL that is disposed over the fourth conductive part 331d through a contact hole 381. Accordingly, the data signal line SL also functions as a source electrode, and voltage in accordance with a digital image signal is applied to the pixel forming portion 310 from the data signal lines SL through the contact hole 381.

Meanwhile, the drain region of the TFT is connected to one end of the second conductive part 331b. The drain region is electrically connected to a drain electrode 334 through a contact hole 382, and the drain electrode 334 is electrically connected to a pixel electrode 351, which is formed so as to cover the pixel forming portion 310, through a through-hole 383. The drain region is electrically connected to the pixel electrode 351 in this manner.

The first conductive part 331a is disposed so as to face the auxiliary capacitance wiring line Cs, a part of which functions as the auxiliary capacitance electrode 342, and is connected to the other end of the second conductive part 331b. The first conductive part 331a forms an auxiliary capacitance along with the auxiliary capacitance wiring line Cs, and functions as an auxiliary opposite electrode of the auxiliary capacitance. The auxiliary capacitance wiring line Cs is applied from the auxiliary capacitance wiring driver circuit with potential that has the same value as the common potential applied to the opposite electrode.

Moreover, the auxiliary capacitance wiring line Cs is applied with the common potential from the opposite electrode as well, in order to be insusceptible to the parasitic capacitance, which occurs at the intersection 111 of the auxiliary capacitance wiring line Cs and the data signal line SL. To do this, a contact hole 384 and a through-hole 385 are formed over the auxiliary capacitance wiring line Cs. The contact hole 384 lets the auxiliary capacitance wiring line Cs electrically connect to an intermediate pad 343, which is formed in the same conductive layer as the drain electrode 334, and the through-hole 385 lets the intermediate pad 343 electrically connect to a contact pad 344, which is formed in the same conductive layer as the pixel electrode 351. When the opposite electrode is in contact with the contact pad 344, the common potential that is applied to the opposite electrode is supplied to the auxiliary capacitance wiring line Cs through the contact pad 344 and the intermediate pad 343. Furthermore, the contact pad 344 is formed apart from the pixel electrode 351.

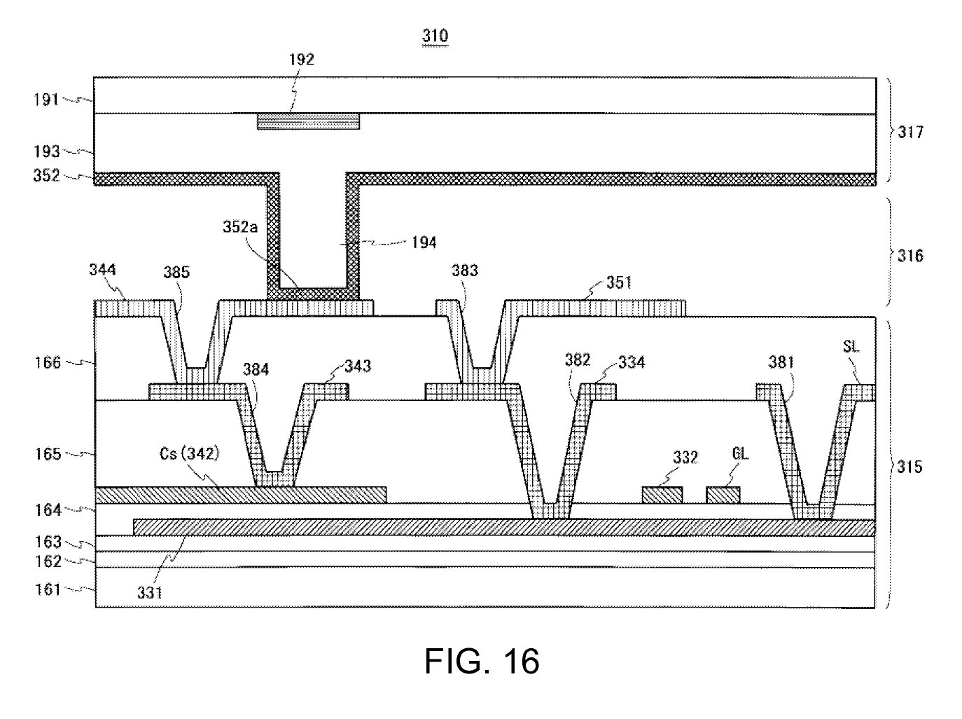

FIG. 16 is a cross-sectional view along the line E-E of the pixel forming portion 310 shown in FIG. 15. The cross-sectional view shown in FIG. 16 is substantially the same as the cross-sectional view shown in FIG. 6, and therefore, only key points are described, and a detailed description is omitted. As shown in FIG. 16, in the TFT substrate 315, the first basecoat film 162 and the second basecoat film 163 are formed on a surface of the glass substrate 161 in sequence.

Formed on a surface of the second basecoat film 163 is the semiconductor layer 331, which functions as a channel part of the TFT and as an auxiliary opposite electrode of an auxiliary capacitance. This semiconductor layer 331 is composed of polycrystalline silicon. Further, the gate insulating film 164 is formed so as to cover the semiconductor layer 331. On a surface of the gate insulating film 164, the gate electrode 332, the scan signal line GL, and the auxiliary capacitance wiring line Cs, a part of which functions as the auxiliary capacitance electrode 342, are formed in the same conductive layer. The interlayer insulating film 165 is further formed so as to cover the gate electrode 332, the scan signal line GL, and the auxiliary capacitance wiring line Cs.

In the interlayer insulating film 165, the contact hole 384 that reaches the auxiliary capacitance wiring line Cs, and two contact holes 381 and 382 that respectively reach the semiconductor layer 331 are formed across the gate electrode 332. Moreover, the intermediate pad 343, which is electrically connected to the auxiliary capacitance wiring line Cs through the contact hole 384; the data signal line SL, which functions as a source electrode; and the drain electrode 334 are formed in the same conductive layer, and the data signal line SL and the drain electrode 334 are electrically connected to the semiconductor layer 331 through the contact holes 381 and 382, respectively.

The resin film 166 is formed so as to cover the intermediate pad 343, the drain electrode 334, and the data signal line SL. In the resin film 166, the through-holes 383 and 385 that reach the drain electrode 334 and the intermediate pad 343, respectively, are formed. Formed on a surface of the resin film 166 are the pixel electrode 351 and the contact pad 344 made of a transparent metal. The pixel electrode 351 is electrically connected to the drain electrode 334 through the through-hole 383. Moreover, the contact pad 344 is formed apart from the pixel electrode 351 so that potential different from the pixel electrode 351 can be applied, and the contact pad 344 is electrically connected to the intermediate pad 343 through the through-hole 385.

Described next is a CF substrate 317, which is disposed facing the TFT substrate 315 through a liquid crystal layer 316. In the CF substrate 317, the color filter layer 193 is formed on a surface on the liquid crystal layer 316 side (the lower side in FIG. 16) of the glass substrate 191. Further, the protruding columnar spacer 194 is disposed at a position facing the contact pad 344.

An opposite electrode 352 is formed on a surface of the color filter layer 193, and on the side surfaces and the bottom surface (surface in contact with the contact pad 344) of the spacer 194. Because a common potential is applied to the opposite electrode 352, by bringing the opposite electrode 352a, which is formed at the bottom surface of the spacer 194, in contact with the contact pad 344, the opposite electrode 352 is electrically connected to the auxiliary capacitance wiring line Cs through the contact pad 344 and the intermediate pad 343. Therefore, the common potential applied to the opposite electrode 352 is also applied to the auxiliary capacitance wiring line Cs. On a surface of the glass substrate 191 on the liquid crystal layer 316 side (lower side in FIG. 16) that corresponds to the spacer 194, the light-shielding layer 192 called a black matrix is formed.

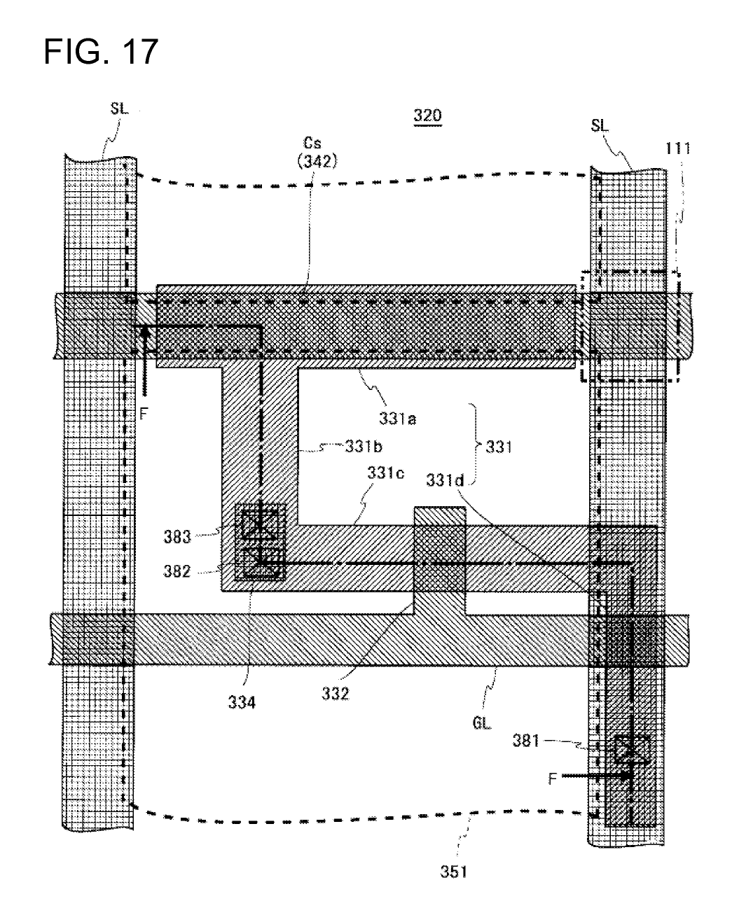

Described next is the pattern arrangement of respective components of the pixel forming portion 320. FIG. 17 is a view showing the pattern arrangement of the pixel forming portion 320. Here, in the pixel forming portion 320, components same as the ones in the pixel forming portion 310 shown in FIG. 15 have the same reference numbers.

In the pixel forming portion 320, unlike the pixel forming portion 310, the auxiliary capacitance wiring line Cs is not electrically connected to the opposite electrode. Therefore, as shown in FIG. 17, the contact pad and the intermediate pad over the auxiliary capacitance wiring line Cs, which are formed in the pixel forming portion 310, are not formed in the pixel forming portion 320. Accordingly, potential of the auxiliary capacitance wiring line Cs is determined only by potential applied from the auxiliary capacitance wiring driver circuit. Here, the pattern arrangement of components constituting the TFT is same as the pattern arrangement of the TFT shown in FIG. 15, and therefore, the description of the arrangement is omitted.

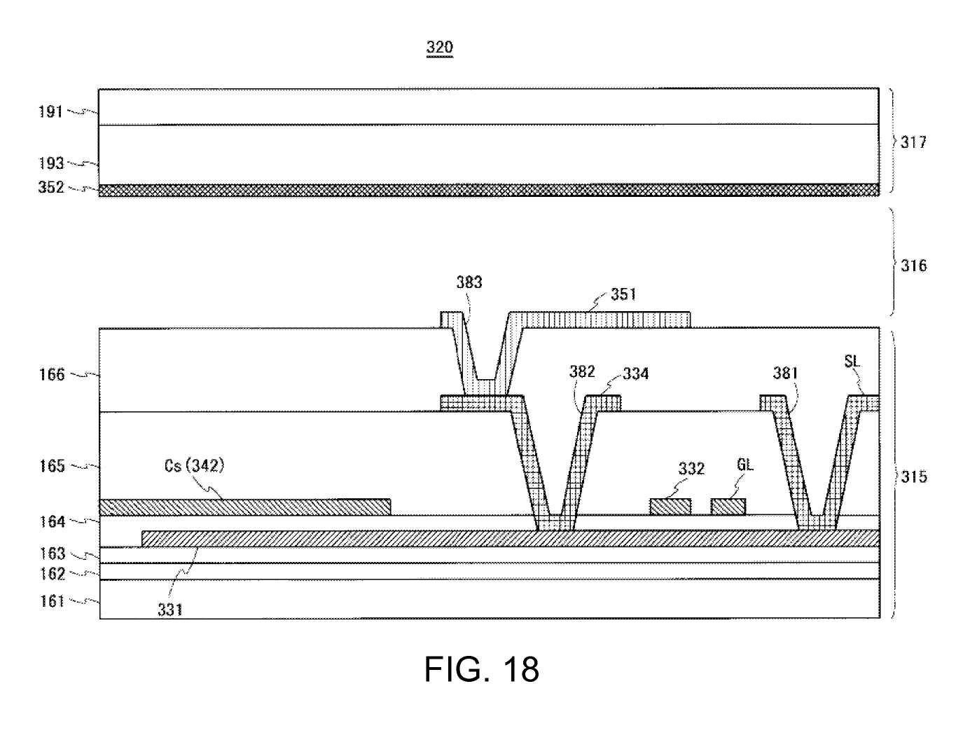

FIG. 18 is a cross-sectional view along the line F-F of the pixel forming portion 320 shown in FIG. 17. In the pixel forming portion 320, components same as the ones in the pixel forming portion 310 shown in FIG. 16 have the same reference numbers. As described above, unlike the pixel forming portion 310, the spacer is not formed in the pixel forming portion 320, and therefore, the intermediate pad 343 and the contact pad 344, which are formed in the pixel forming portion 310, become unnecessary. Thus, as shown in FIG. 18, unlike the pixel forming portion 310, the pixel forming portion 320 does not include the contact hole formed on the auxiliary capacitance wiring line Cs, the intermediate pad formed to cover the contact hole, the through-hole formed on the intermediate pad, or the contact pad formed to cover the through-hole. Furthermore, the arrangement of respective components of the TFT is same as the arrangement of the components of the TFT in the pixel forming portion 310 shown in FIG. 16, and therefore, the description is omitted.

<3.2 Effects>

As can be understood from the description above, the pixel forming portion 310 has the same effects as the pixel forming portion 110 of Embodiment 1, and the pixel forming portion 320 has the same effects as the pixel forming portion 120 of Embodiment 1. Further, in the liquid crystal panel of the present embodiment, each of the pixel forming portions 310 is disposed for a predetermined number of the pixel forming portions 320, and therefore, the liquid crystal panel of the present embodiment has the same effects as the liquid crystal panel 10 of Embodiment 1. Thus, the detailed description of those effects is omitted.

In the pixel forming portion 310 and the pixel forming portion 320, the auxiliary capacitance wiring line Cs, which functions as the auxiliary capacitance electrode 342, is disposed outside the scan signal line GL, and the first conductive part 331a, which functions as an auxiliary opposite electrode, is disposed in a region that is under the auxiliary capacitance wiring line Cs and that is between the two adjacent data signal lines SL. In this case, the area of the first conductive part 331a, which faces the auxiliary capacitance wiring line Cs, can be made as large as possible, and therefore, it is possible to increase the capacitance value of the auxiliary capacitance that is constituted of the first conductive part 331a and the auxiliary capacitance wiring line Cs.

### 4. Embodiment 4

The configuration of a liquid crystal display device of Embodiment 4 is the same as the liquid crystal display device shown in FIG. 1; the circuit diagrams of pixel forming portions 410 and 420 included in a liquid crystal panel of the present embodiment are the same as the circuit diagram of the pixel forming portion 210 shown in FIG. 9(a) and the circuit diagram of the pixel forming portion 220 shown in FIG. 9(b), respectively; and the arrangements of the pixel forming portions 410 and 420 in the liquid crystal panel are the same as the arrangements of the pixel forming portions 210 and 220 shown in FIG. 10. Therefore, their description is omitted.

<4.1 Pattern Arrangements of Pixel Forming Portions>

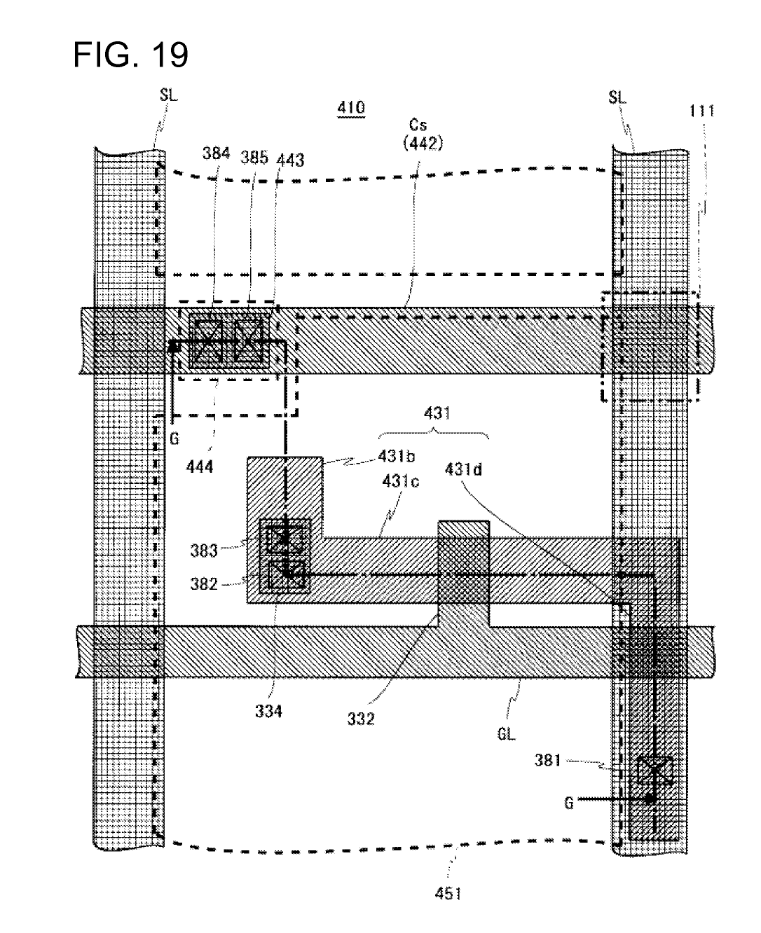

The pattern arrangements of the pixel forming portion 410 and the pixel forming portion 420 included in the liquid crystal panel of Embodiment 4 are described. These pattern arrangements are arrangements often suited for a pixel forming portion including a polycrystalline silicon TFT as in the case of the pixel forming portion 310 and the pixel forming portion 320 of Embodiment 3. FIG. 19 is a view showing the pattern arrangement of respective components of the pixel forming portion 410. As shown in FIG. 19, in the pixel forming portion 410 as well, the auxiliary capacitance wiring line Cs, a part of which functions as the auxiliary capacitance electrode 442, is disposed in parallel with the scan signal line GL. However, unlike the pixel forming portion 310 shown in FIG. 15, a semiconductor layer corresponding to the first conductive part 331a in FIG. 15 is not formed under the auxiliary capacitance wiring line Cs in the pixel forming portion 410. The pattern arrangement of the TFT is the same as the pattern arrangement of the TFT in the pixel forming portion 110 shown in FIG. 15, and therefore, the description is omitted.

In the pixel forming portion 410, a common potential is applied to the auxiliary capacitance wiring line Cs from the opposite electrode in the same way as in the pixel forming portion 310, and therefore, the contact hole 384 and the through-hole 385 are formed over the auxiliary capacitance wiring line Cs. The contact hole 384 lets the auxiliary capacitance wiring line Cs electrically connect to an intermediate pad 443, which is formed in the same conductive layer as the drain electrode 334, and the through-hole 385 lets the intermediate pad 443 electrically connect to a contact pad 444, which is formed in the same conductive layer as the pixel electrode 451. Therefore, when the common potential is applied to the contact pad 444, the common potential is also applied to the auxiliary capacitance wiring line Cs through the contact pad 444 and the intermediate pad 443.

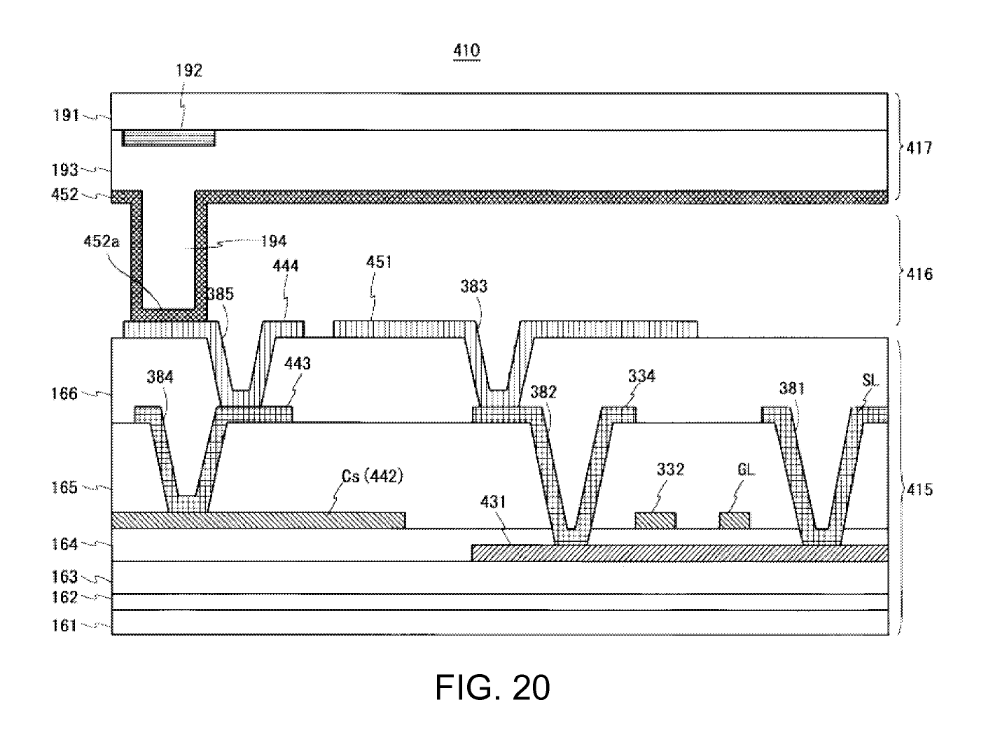

FIG. 20 is a cross-sectional view along the line G-G of the pixel forming portion 410 shown in FIG. 19. Here, in the pixel forming portion 410 shown in FIG. 20, components same as the ones in the pixel forming portion 310 shown in FIG. 16 have the same reference numbers.

As shown in FIG. 20, in the pixel forming portion 410, unlike the pixel forming portion 310 shown in FIG. 16, a semiconductor layer 431 formed in the TFT substrate 415 is only formed in a channel part of the TFT, and does not extend to the lower side of the auxiliary capacitance wiring line Cs. Moreover, the auxiliary capacitance wiring line Cs is electrically connected to the intermediate pad 443 through the contact hole 384, and the intermediate pad 443 is electrically connected to the contact pad 444 through the through-hole 385.

Meanwhile, in a CF substrate 417, the spacer 194 is formed so as to face the contact pad 444, and an opposite electrode 452a, which is formed at the bottom surface of the spacer 194, is in contact with the contact pad 444. Accordingly, the opposite electrode 452 is electrically connected to the auxiliary capacitance wiring line Cs through the contact pad 444 and the intermediate pad 443, and therefore, the common potential is also applied to the auxiliary capacitance wiring line Cs from the opposite electrode 452.

Furthermore, the auxiliary capacitance wiring line Cs is disposed so as to face a part of the pixel electrode 451 through the interlayer insulating film 165 and the resin film 166. Accordingly, in the pixel forming portion 410, an auxiliary capacitance is constituted of the auxiliary capacitance wiring line Cs, the pixel electrode 451, and the interlayer insulating film 165 as well as the resin film 166 interposed therebetween.

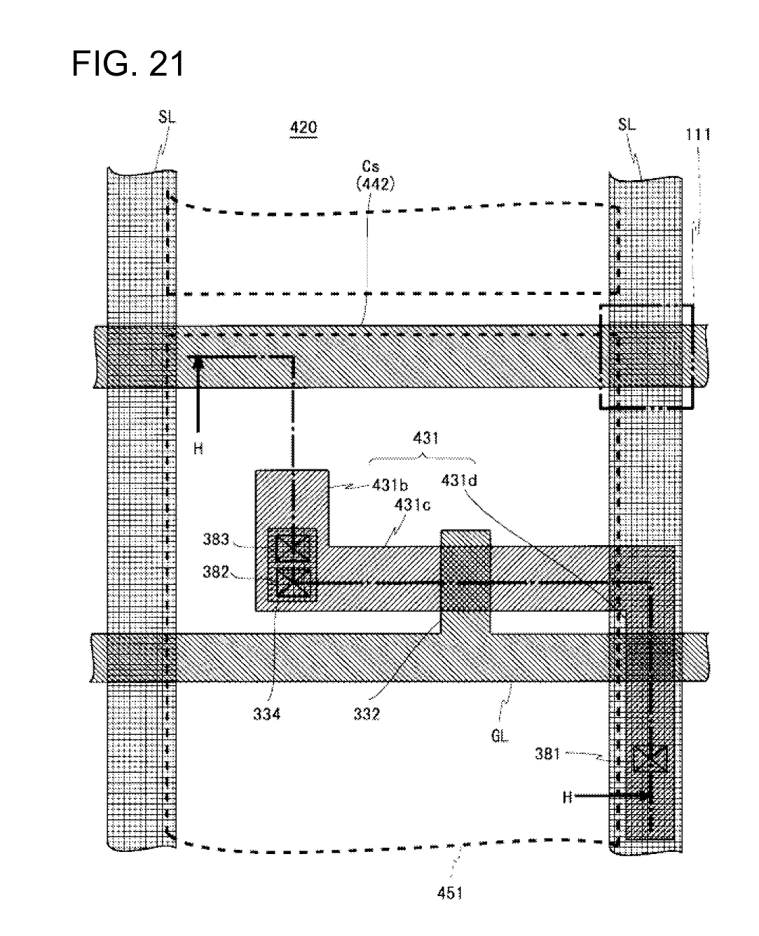

Next, the configuration of the pixel forming portion 420 is described. FIG. 21 is a view showing the pattern arrangement of respective components of the pixel forming portion 420. Here, in the pixel forming portion 420 shown in FIG. 21, components same as the ones in the pixel forming portion 410 shown in FIG. 19 have the same reference numbers.

In the pixel forming portion 420, unlike the pixel forming portion 410, the auxiliary capacitance wiring line Cs is not electrically connected to the opposite electrode.

Therefore, as shown in FIG. 21, the contact pad and the intermediate pad, which are necessary to apply the common potential to the auxiliary capacitance wiring line Cs from the opposite electrode, are not formed. Therefore, potential of the auxiliary capacitance wiring line Cs is determined only by potential applied from the auxiliary capacitance wiring driver circuit. The pattern arrangement of components constituting the TFT is same as the pattern arrangement of the TFT shown in FIG. 19, and therefore, the description is omitted.

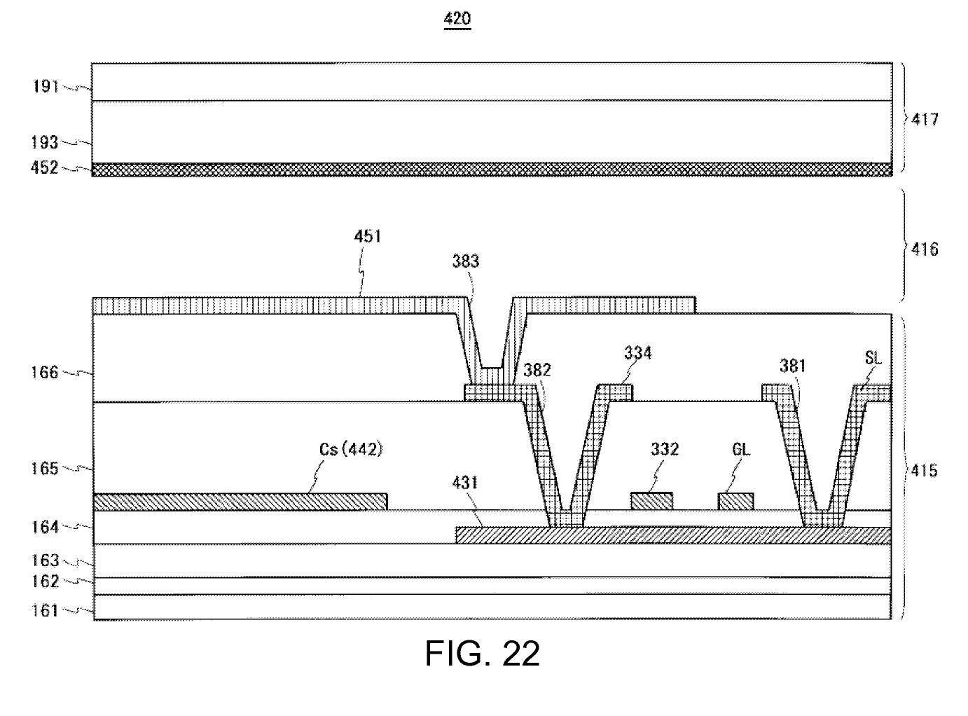

FIG. 22 is a cross-sectional view along the line H-H of the pixel forming portion 420 shown in FIG. 21. In the pixel forming portion 420 shown in FIG. 22, components same as the ones in the pixel forming portion 410 shown in FIG. 20 have the same reference numbers. As described above, unlike the pixel forming portion 410, the spacer is not formed in the pixel forming portion 420, and therefore, the intermediate pad and the contact pad become unnecessary. Accordingly, as shown in FIG. 22, the pixel forming portion 420 does not include the contact hole formed on the auxiliary capacitance wiring line Cs, the intermediate pad formed to cover the contact hole, the through-hole formed on the intermediate pad, or the contact pad formed to cover the through-hole. Further, the arrangement of components constituting the TFT is the same as the arrangement of the components of the TFT shown in FIG. 20, and therefore, the description is omitted.

<4.2 Effects>

As shown in the description above, the pixel forming portion 410 has the same effects as the pixel forming portion 110 of Embodiment 1, the pixel forming portion 420 has the same effects as the pixel forming portion 120 of Embodiment 1. Moreover, each of the pixel forming portions 410 is disposed for a predetermined number of the pixel forming portions 420 in the liquid crystal panel of the present embodiment, thereby achieving the same effects as the liquid crystal panel 10 of Embodiment 1. Thus, the detailed description of those effects is omitted.

### 5. Modified Examples

In Embodiment 1, each of the pixel forming portions 110 is disposed for a predetermined number of the pixel forming portions 120 in the liquid crystal panel 10. However, a liquid crystal panel in which only the pixel forming portions 110 are disposed and no pixel forming portion 120 is disposed may be used as well. In this case, the aperture ratio of the entire liquid crystal panel becomes smaller, but the auxiliary capacitance wiring line Cs of the pixel forming portion 110 is connected to the opposite electrode 152 through the opposite electrode 152a formed at the bottom surface of the spacer 194, and therefore, the auxiliary capacitance wiring line Cs of the pixel forming portion 110 is also applied with the common potential from the opposite electrode 152. Accordingly, even if potential of the auxiliary capacitance wiring line Cs is drawn in by the effect of the parasitic capacitance at the intersection 111 of the auxiliary capacitance wiring line Cs and the data signal line SL, the potential of the auxiliary capacitance wiring line Cs is quickly recovered to the original common potential before the gate of the TFT 130 becomes an off-state. Thus, in such a liquid crystal panel, the potential of the auxiliary capacitance wiring line Cs becomes insusceptible to a change in potential of the adjacent data signal lines SL, and therefore, the occurrence of a horizontal crosstalk can be suppressed.

Although the above-mentioned description explained the liquid crystal panel 10 in which only the pixel forming portions 110 of Embodiment 1 are provided, but a liquid crystal panel 11 in which only the pixel forming portions 210 of Embodiment 2 are provided, a liquid crystal panel in which only the pixel forming portions 310 of

Embodiment 3 are provided, and a liquid crystal panel in which only the pixel forming portions 410 of Embodiment 4 are provided are also possible.

Further, a description was made in Embodiments 1 to 4 that the TFT 130 included in the pixel forming portions is a top-gate type TFT, but it may also be a bottom-gate type TFT. Also, a liquid crystal panel and a liquid crystal display device were described in Embodiments 1 to 4, but the present invention can also be applied to an organic EL (Electro Luminescence) panel and an organic EL display device as well.

### INDUSTRIAL APPLICABILITY

The display panel of the present invention is applied to a display panel in a display device, and is capable of suppressing the occurrence of a horizontal crosstalk and ensuring the aperture ratio of the entire display panel.

### DESCRIPTION OF REFERENCE CHARACTERS

10,11 liquid crystal panels

50 auxiliary capacitance wiring line circuit

110, 120, 210, 220, 310, 320, 410, 420 pixel forming portions

115, 215, 315, 415 Thin Film Transistor (TFT) substrates

117, 217, 317, 417 Color Filter (CF) substrates

130 Thin Film Transistor (TFT)

131, 231, 331, 431 semiconductor layers

140, 240 auxiliary capacitances

141 auxiliary opposite electrode

142, 242 auxiliary capacitance electrodes

144, 244, 344, 444 contact pads

150, 250 pixel capacitances

151, 251 pixel electrodes

152, 252, 352, 452 opposite electrodes

152a, 252a, 352a, 452a opposite electrodes formed at the bottom of spacer

192 light-shielding layer

194 spacer

GL scan signal line

SL data signal line

Cs auxiliary capacitance wiring line

1. An active matrix system display panel, comprising: a first insulating substrate having a data signal line, a scan signal line, an auxiliary capacitance wiring line formed so as to intersect with said data signal line, and a plurality of first pixel forming portions; and a second insulating substrate that is disposed to face said first insulating substrate, and that has an opposite electrode formed commonly for said plurality of first pixel forming portions,
wherein each of said plurality of first pixel forming portions comprises:
a pixel capacitance formed by a pixel electrode and said opposite electrode; and
an auxiliary capacitance formed by an auxiliary capacitance electrode connected to said auxiliary capacitance wiring line, which is to be applied with potential synchronized with potential of said opposite electrode, and by an auxiliary opposite electrode that is disposed to face said auxiliary capacitance electrode and that is connected to said pixel electrode, and
wherein said auxiliary capacitance electrode of said first pixel forming portion is further connected to said opposite electrode within said first pixel forming portion.

2. The display panel according to claim 1, further comprising a plurality of second pixel forming portions formed on said first insulating substrate,
wherein said opposite electrode is also formed commonly for said plurality of second pixel forming portions, and
wherein each of said plurality of second pixel forming portions comprises:
a pixel capacitance that is formed by a pixel electrode and said opposite electrode; and
an auxiliary capacitance that is formed by an auxiliary capacitance electrode connected to said auxiliary capacitance wiring line, which is to be applied with potential synchronized with potential of said opposite electrode, and an auxiliary opposite electrode that is disposed to face said auxiliary capacitance electrode and that is connected to said pixel electrode.

3. The display panel according to claim 1,
wherein said first pixel forming portion further comprises a columnar spacer part that has a surface in which a part of said opposite electrode is formed, and a contact electrode that is electrically connected to said auxiliary capacitance electrode, and
wherein an opposite electrode formed on said surface of said spacer part is in contact with said contact electrode.

4. The display panel according to claim 2, wherein each of said first pixel forming portions is disposed for a predetermined number of said second pixel forming portions.

5. The display panel according to claim 2,
wherein said first and second pixel forming portions include a thin film transistor, and
wherein said auxiliary opposite electrode is unitarily formed with a channel part of said thin film transistor.

6. The display panel according to claim 2,
wherein said first and second pixel forming portions include a thin film transistor,
wherein said auxiliary capacitance electrode is disposed outside said scan signal line,
wherein said auxiliary opposite electrode is disposed in a region that is under said auxiliary capacitance wiring line and that is interposed between two of said data signal lines adjacent to each other, and
wherein said thin film transistor is formed in a region that is interposed between said auxiliary capacitance wiring line and said scan signal line.

7. The display panel according to claim 2, wherein said auxiliary opposite electrode is said pixel electrode.

8. The display panel according to claim 2, wherein said auxiliary capacitance electrode is made of a part of said auxiliary capacitance wiring line.

9. The display panel according to claim 3, wherein said spacer part includes a light-shielding layer that is formed so as to cover a surface opposite to a surface in contact with said auxiliary capacitance electrode.

10. A display device comprises the display panel according to claim 1.
